(19) United States
(12) Patent Application Publication
(10) Pub. No.: US 2020/0311653 A1
(43) Pub. Date: Oct. 1, 2020

(54) SYSTEM AND METHOD FOR DELIVERIES OF PARCELS

(71) Applicant: QUAY EXPRESS LTD, Kfar Chabad (IL)

(72) Inventors: Yossi RABINOVITZ, Kfar Chabad (IL); Yitzhak MUSHKIN, Ha'rel (IL); Carmi RAZ, Gizo (IL)

(21) Appl. No.: 16/759,569

(22) PCT Filed: Nov. 28, 2018
(86) PCT No.: PCT/IB2018/059428

§ 371 Date: Apr. 28, 2020

Related U.S. Application Data
(60) Provisional application No. 62/591,743, filed on Nov. 28, 2017.
(60) Provisional application No. 62/592,541, filed on Nov. 30, 2017.
(60) Provisional application No. 62/593,036, filed on Nov. 30, 2017.
(60) Provisional application No. 62/614,426, filed on Jan. 7, 2018.

(51) Int. Cl. G06Q 10/08; G06Q 10/06; G06F 16/23; G06Q 50/28

(52) U.S. Cl. CPC G06Q 10/083; G06Q 50/28; G06F 16/2365; G06Q 10/0639

(57) ABSTRACT

A system and method for managing the deliveries of parcels, and the like, that allows senders, couriers, recipients, and others, access via personal devices configured for arranging and controlling the delivery services between each other without meetings. The system and method include package delivery unit design to warp and secure parcels and fit to be bold and lock by holder device and have identification means to recognize and manage delivery. The system and method include network of holder devices at different locations design to hold, identify and lock the package delivery unit and can communicate with other holder devices and/or personal devices configured to recognize and manage delivery.

### CROSS-REFERENCE TO RELATED APPLICATIONS

The present application claims the benefit of U.S. Provisional Application Ser. No. 62/591,743 filed Nov. 29, 2017, U.S. Provisional Application Ser. No. 62/592,541 filed Nov. 30, 2017, U.S. Provisional Application Ser. No. 62/593,036 filed Nov. 30, 2017 and U.S. Provisional Application Ser. No. 62/614,426 filed Jan. 7, 2018, the disclosure of which is expressly incorporated by reference herein in its entirety.

### FIELD OF THE INVENTION

The present invention generally relates to the delivery of parcels, and more particularly to a system and method for managing the delivery of parcels, and the like, by individual couriers, and the like.

### BACKGROUND OF THE INVENTION

Systems have been developed for deliveries of parcels and managing deliveries of parcels. For example, various companies manage dedicated logistics facilities, vehicles and operators, and provide parcel delivery services to individuals. Similarly, retailers manage delivery of merchandise purchased by consumers to homes of the consumers. However, such systems and methods typically lack robustness with respect to managing deliveries of parcels by some managing services, retail infrastructures, organizations lacking logistics, and the like. Some delivery system requires personal encounters between senders to transporters or/and transporters to precipitants that add restrains. In addition, such systems and methods typically suffer from lack of convenience and ease of use, for example, by individuals for whom such delivery of parcels is just one activity among many daily routines.

### SUMMARY OF THE INVENTION

Therefore, there is a need for a method and system that addresses the above and other problems. The above and other problems are addressed by the illustrative embodiments of the present invention, which provide a system and method for managing the deliveries of parcels, and the like, and that allows senders, couriers, recipients, and the like, access via personal devices configured for arranging and controlling the delivery services between each other without meetings. The system and method can include package delivery unit design to warp and secure parcels and fit to be hold and lock by holder device and have identification means to recognize and manage delivery. The system and method can include network of holder devices at different locations design to hold, identify and lock the package delivery unit and can communicate with other holder devices and/or personal devices configured to recognize and manage delivery. The system and method can include a personal device configured to register senders, receive package delivery unit associated information data and communicates instructions with the sender during the delivery process. the system and method can include a personal device configured to control access to holder devices, register couriers, approach couriers for a delivery, and communicates instructions with the couriers during the delivery process. the system and method can include a personal device configured to control access to holder devices, register recipient, and communicates instructions with the recipient during the delivery process. the holder device controller configured among other to, receive the package delivery unit associate information and location, plan deliveries, communicate with other holder device controllers, approach couriers to conduct deliveries, and communicates instructions with senders, couriers and recipient personal devices.

Accordingly, in illustrative aspects of the present invention there is provided a system, method, and computer program product for managing the deliveries of parcels, including a network of holder devices; a package delivery unit, and couriers. The holder device is design to hold, identify and lock package delivery units and configured for identifying package delivery units and communicate other holder devices controllers for routing and sending and receiving data, and is configured to allow access to the package delivery unit for at least one of transport based on the package delivery unit associate information. The couriers can be communicated by personal device to transport a package delivery unit from one holder device to other holder device on the network of holder devices and to allow access to the package delivery unit on holder device. The holder device is additionally configured receive package delivery unit associate information, plan a delivery routes in accordance of package delivery unit associate information and holder devices locations and designating and allowing access to courier to transport the package delivery unit from holder device to another holder device according to planned route.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWING

The embodiments of the present invention are illustrated by way of example, and not by way of limitation, in the figures of the accompanying drawings and in which like reference numerals refer to similar elements and in which;

FIG. 1A shows an illustrative perspective view of holder device, in accordance with exemplary embodiment of present invention.

FIG. 1B shows an illustrative perspective view of holder device, in accordance with exemplary embodiment of present invention.

FIG. 2 shows an illustrative front view and side view of package delivery unit, in accordance with exemplary embodiment of present invention.

FIG. 3 shows an illustrative perspective view of holder device and package delivery units, in accordance with exemplary embodiment of present invention.

FIG. 4A shows an illustrative perspective view of holder device, in accordance with exemplary embodiment of present invention.

FIG. 4B shows an illustrative perspective view of holder device, in accordance with exemplary embodiment of present invention.

FIG. 5A shows an illustrative front view of package delivery unit, in accordance with exemplary embodiment of present invention.

FIG. 5B shows an illustrative perspective view of package delivery unit, in accordance with exemplary embodiment of present invention.

FIG. 6 shows an illustrative perspective view of holder device and package delivery units, in accordance with exemplary embodiment of present invention.

FIG. 7 shows an illustrative example of a holder device controller, in accordance with exemplary embodiment of present invention.

FIG. 7B shows an illustrative example of a holder device controller, in accordance with exemplary embodiment of present invention.

FIG. 8 shows an illustrative example of computer system that can be used to preform various process by users, in accordance with exemplary embodiment of present invention.

FIG. 8B shows an illustrative example of computer system that can be used to preform various process by users, in accordance with exemplary embodiment of present invention.

FIG. 9 shows an illustrative delivery system and method, in accordance with exemplary embodiment of present invention.

FIG. 9B shows an illustrative delivery system and method, in accordance with exemplary embodiment of present invention.

FIG. 10 shows an illustrative deployment of delivery system and method, in accordance with exemplary embodiment of present invention.

FIG. 11 shows an illustrative delivery system and method, in accordance with exemplary embodiment of present invention.

FIG. 11B shows an illustrative delivery system and method, in accordance with exemplary embodiment of present invention.

FIG. 12 shows illustrative flowchart of processes performed by a delivery system and method in an exemplary package delivery unit sending procedure.

FIG. 13 shows illustrative flowchart of processes performed by a delivery system and method in an exemplary package delivery unit transport procedure.

FIG. 14 shows illustrative flowchart of processes performed by a delivery system and method in an exemplary package delivery unit receiving procedure.

FIG. 15 shows illustrative flowchart of processes performed by a delivery system and method in an exemplary package delivery unit sending procedure.

FIG. 16 shows illustrative flowchart of processes performed by a delivery system and method in an exemplary package delivery unit transport procedure.

FIG. 17 shows illustrative flowchart of processes performed by a delivery system and method in an exemplary package delivery unit receiving procedure.

### DETAILED DESCRIPTION OF THE PREFERRED EMBODIMENTS

A system and method for delivery of parcels by individual couriers are described. In the following description, for purposes of explanation, numerous specific details are set forth in order to provide a thorough understanding of the present invention. It is apparent to one skilled in the art, however, that the present invention may be practiced without these specific details or with an equivalent arrangement. In some instances, well-known structures and devices are shown in block diagram form in order to avoid unnecessarily obscuring the present invention.

Generally, the system and method can include package delivery unit design to warp and secure parcels and fit to be hold and lock by holder device and have identification means to recognize and manage delivery. the system and method can include network of holder devices at different locations design to hold, identify and lock the package delivery unit and communicate with other holder devices controllers and users personal devices and configured to authorize and control access to a package delivery unit. the system and method can include a personal device configured to register senders, receive package delivery unit associated information data and communicates instructions with the sender during the delivery process.

the system and method can include a personal device configured to control access to holder devices, register couriers, approach couriers for a delivery, and communicates instructions with the couriers during the delivery process. the system and method can include a personal device configured to control access to holder devices, register recipient, and communicates instructions with the recipient during the delivery process. the holder device controller configured among other to, receive the package delivery unit associate information, plan deliveries, approach couriers to conduct deliveries, and communicates instructions with other holder devices, senders, couriers and recipient personal devices.

Accordingly, in illustrative aspects of the present invention there is provided a system, method, and computer program product for managing the deliveries of parcels, including a network of holder devices; a package delivery unit, and couriers. The holder device is design to hold, identify and lock package delivery units and configured for identifying package delivery units and managing delivery process, communicate other holder device sending and receiving identified package delivery units and holder device data and is configured to allow access to the package delivery unit for at least one of transport based on the package delivery unit associate information. The couriers can be communicated by personal device to transport a package delivery unit from one holder device to other holder device on the network of holder devices and to allow access to the package delivery unit on holder device. The holder device controller is configured among other to receive package delivery unit associate information and other holder devices data, plan a delivery routes in accordance of package delivery unit associate information and holder devices locations and designating and allowing access to courier to transport the package delivery unit from holder device to another holder device according to planned route.

The present invention includes recognition of the competitive disadvantages of delivery services dependent on logistics networks, compared to the low marginal operating expenditures of private vehicles driven by occasional drivers or designated drivers. The present invention provides a solution by allowing a delivery service to benefit from the same low marginal operating expenditures of private vehicles driven by occasional drivers or designated drivers.

The present invention also includes recognition of the structural dependency on the use of private vehicles in visiting car accessible businesses, such as hypermarkets, and the like, that have driven competition out of business and now represent high percentage of sales in many economies. With road transportation over 95% dependent on oil as its primary source of energy, and the price of oil rising faster than overall inflation, such structural dependency reduces the purchasing power of consumers available for other consumption. The present invention provides a solution by significantly increasing the fuel efficiency of private vehicles through the transport of goods alongside the primary purpose of driving.

The adoption of ride sharing and crowd source taxi solution has shown that individuals are willing to provide personal transportation services to each other. The adoption of home delivery services has shown that individuals are willing to offload transportation of everyday goods to others. However, the present invention also includes recognition that the transportation by individuals requires a significant effort to manage the associated logistics, costs and uncertainties. The present invention provides a solution to reduce such efforts, and provide convenience to the users.

According to an embodiment, provided is a computer implemented delivery system comprising: network of holder devices; package delivery unit; plurality of couriers with a courier interface device; the holder device having an automatic identification and data capture (AIDC) reader, a lock and a controller having a processor, a memory and a communication network interface; the package delivery unit design to be held and locked by the holder device and having an identification code and AIDC tag; the courier interface device having a processor, a memory and a communication network interface; the processor and memory on the holder device controller being configurated to retrieve identification information from the AIDC reader, operate the lock, run a database process and delivery management process, and communicate with other holder device controllers and courier interface device over the communication network interface; the processor and memory on the courier interface device being configurated to run database process and delivery management process and communicate the holder device controllers over the communication network interface; the holder device controller is configured to receive and store package delivery unit associated information; the package delivery unit associated information comprises package delivery unit destination and the package delivery unit identification code; the courier interface device being configurated to receive courier associated information and being configurated to communicate the holder device controller over the communication network interface and transfer the courier associated information; the holder device controller is configured to store the courier associated information received from the courier interface device; the courier associated information comprises courier location, courier destination and courier identification data; the holder device controller comprises a stored routing table to other holder devices; the holder device controller is configured to access the stored databases and identify next holder devices location based on the package delivery unit associated information and at least one courier associated information; the holder device controller is configured to access the stored databases and match at least one of the identify next holder devices location and identified courier interface device and stored routing table, communicate identified courier interface device over the communication network interface and transfer next holder device location;

the holder device controller is configured to open the package delivery unit lock for identified courier interface device.

According to an embodiment, the computer implemented delivery system, further comprising a sender and a sender interface device; the sender interface device having a processor, a memory and a communication network interface; the processor and memory on the sender interface device being configurated to run database process and delivery management process and communicate the holder device controllers over the communication network interface; the sender interface device being configurated to receive package delivery unit associated information and being configurated to communicate the holder device controller over the communication network interface and transfer the package delivery unit associated information, when the package delivery unit is placed in the holder device.

According to an embodiment, the sender provides the package delivery unit associated information to the sender interface device. According to an embodiment, the sender places the package delivery unit to holder device.

According to an embodiment, the routing table are based on Anycast routing, Geographic routing, hybrid routing or any combination thereof.

According to an embodiment, the holder device controller communication with other holder devices controller comprise data on current and statistic holder device occupancy and wherein the holder device controller can update routing table in accordance to data. According to an embodiment, the holder device controller further receive data comprising at least one of weather condition, road condition, traffic, news data, statistic road use data, courier's statistic data, statistic packages delivery unit data. and wherein the holder device controller can update routing table in accordance to at least one of receive data.

According to an embodiment, the holder device capable to hold and lock more than one package delivery unit and capable to associate package delivery unit identification code and holding position on the holder device.

According to an embodiment, the network of holder devices comprises at least 10 holder devices.

According to an embodiment, the AIDC is one of an RFID device, NFC device, Smart card device, Barcode device, QR code device and a Magnetic strip device.

According to an embodiment, the AIDC is RFID device.

According to an embodiment, the package delivery unit comprises a secure, one timer and detectable mark opening.

According to an embodiment, the sender interface device comprises AIDC reader device. According to an embodiment, the sender interface device AIDC reader is a camera or RFID device. According to an embodiment, the sender interface device is a computer or a personal mobile device. According to an embodiment, the courier interface device comprises AIDC reader and/or a tag, and is a computer or a personal mobile device.

According to an embodiment, the courier provides the courier associated information to the courier interface device. According to an embodiment, the match courier removes the package delivery unit from the holder device and place the package delivery unit on next holder device. According to an embodiment, the holder device further comprises an additional AIDC reader and/or a tag. According to an embodiment, the additional AIDC reader and/or a tag uses to recognize courier. According to an embodiment, the couriers can be an occasional courier.

According to an embodiment, the package delivery unit transfer from holder device to holder device by couriers and the package delivery unit delivery from initial placed holder device to closets to destination holder device is done in a relay race.

According to an embodiment, the holder device controller configured to check if is current holder device location is closest to package delivery unit destination and configured to notify destination contact based on destination contact information from package delivery unit associated information. According to an embodiment, the notification to the destination contact can contain an option to self-collecting and can comprise attached AIDC or can contain an option to generate new virtual holder device at destination address.

According to an embodiment, one of the holder device controllers is configured to access the stored databases and identify next holder devices location based on the package delivery unit associated information and at least one courier associated information, and configured to access the stored databases and match at least one of the identify next holder devices location and identified courier interface device and stored routing table, communicate identified courier interface device over the communication network interface and transfer next holder device location. And wherein the others holder device controllers are configured to communicate said controller over the communication network interface and transfer locking position of said package delivery unit, the package delivery unit associated information, and receive command to open the package delivery unit lock. And the courier interface devices being configurated to communicate said one holder device controller over the communication network interface.

According to an embodiment, the system farther comprising central management component that can run a database process and delivery management process, and communicate with holder device controllers and courier interface device over the communication network interface; central management component is configured to access the stored databases and identify next holder devices location based on the package delivery unit associated information and at least one courier associated information, and configured to access the stored databases and match at least one of the identify next holder devices location and identified courier interface device and stored routing table, communicate identified courier interface device over the communication network interface and transfer next holder device location. And wherein the holder device controllers are configured to communicate said central management component over the communication network interface and transfer locking position of said package delivery unit, the package delivery unit associated information, and receive command to open the package delivery unit lock. And the courier interface devices being configurated to communicate said central management component over the communication network interface.

According to an additional embodiment, provided is a delivery system comprising;

network of holder devices at different location each holder device comprising plurality holding position with locks, RFID readers and controller;
package delivery units adapted to be held and lock at holder device position and a RFID tag; plurality of couriers with a courier interface device; wherein holder device controller can communicate courier interface device and receive courier current position and destination and match at least one package delivery unit to be transfer to other holder device on the route of the courier in accordance to routing table;
send suggestion to courier interface device to conduct the transfer;
receive confirmation from courier interface device for transfer; identify courier interface device and operate locks; and communicate other holder device in accordance to routing table on transfer.

According to an embodiment, the delivery system comprising a sender, and wherein the sender places at least one package delivery unit in a holder device.

According to an embodiment, the package delivery unit route from initial holder device to final holder device comprises at least one additional holder device and the courier transfer is a relay race.

According to an embodiment, provided is a computer implemented delivery method comprising; providing network of holder devices; providing package delivery unit; providing plurality of couriers with a courier interface device; providing in the holder device an automatic identification and data capture (AIDC) reader, a lock and a controller having a processor, a memory and a communication network interface;

providing the package delivery unit design to be held and locked by the holder device and having an identification code and AIDC tag; providing in the courier interface device a processor, a memory and a communication network interface; running with the processor and memory on the holder device controller a database process and delivery management process, retrieving identification information from the AIDC reader, operating the lock, and communicating with other holder device controllers and courier interface device over the communication network interface; running with the processor and memory on the courier interface device database process and delivery management process, and communicating the holder device controllers over the communication network interface; receiving and storing to the holder device controller package delivery unit associated information. the package delivery unit associated information comprises package delivery unit destination and the package delivery unit identification code; receiving to the courier interface device courier associated information and communicating the holder device controller over the communication network interface and transferring the courier associated information; storing at the holder device controller the courier associated information received from the courier interface device; the courier associated information comprises courier location, courier destination and courier identification data; the holder device controller comprises a stored routing table to other holder devices; accessing in the holder device controller the stored databases and identifying next holder devices location based on the package delivery unit associated information and at least one courier associated information;
accessing in the holder device controller the stored databases and matching at least one of the identify next holder devices location and identified courier interface device and stored routing table, communicating identified courier interface device over the communication network interface and transferring next holder device location; open the holder device controller the package delivery unit lock for identified courier interface device.

According to an embodiment, the method further providing a sender and a sender interface device; providing the sender interface device having a processor, a memory and a communication network interface; running with the processor and memory on the sender interface device a database process and delivery management process and communicating the holder device controllers over the communication network interface; receive in the sender interface device a package delivery unit associated information and communicating the holder device controller over the communication network interface and transferring the package delivery unit associated information, when the package delivery unit is placed in the holder device. According to an embodiment, the sender provides the package delivery unit associated information to the sender interface device. According to an embodiment, the provided sender places the package delivery unit to holder device.

According to an embodiment, the routing table are based on Anycast routing, Geographic routing, hybrid routing or any combination thereof.

According to an embodiment, the provided holder device controller communication with other holder devices controller comprise data on current and statistic holder device occupancy and provided holder device controller can update routing table in accordance to data.

According to an embodiment, the provided holder device controller further receiving data comprising at least one of weather condition, road condition, traffic, news data, statistic road use data, courier's statistic data, statistic packages delivery unit data. and wherein provided holder device controller can update routing table in accordance to at least one of received data.

According to an embodiment, the provided holder device can hold and lock more than one package delivery unit and can associate package delivery unit identification code and holding position on the holder device.

According to an embodiment, the provided network of holder devices comprises at least 10 holder devices.

According to an embodiment, the provided AIDC is one of an RFID device, NFC device, Smart card device, Barcode device, QR code device and a Magnetic strip device. According to an embodiment, the provided AIDC is RFID device.

According to an embodiment, the provided package delivery unit comprises a secure, one timer and detectable mark opening.

According to an embodiment, the provided sender interface device comprises AIDC reader device. According to an embodiment, the provided sender interface device AIDC reader is a camera or RFID device. According to an embodiment, the provided sender interface device is a computer or a personal mobile device.

According to an embodiment, the provided courier interface device comprises AIDC reader and/or a tag, and is a computer or a personal mobile device.

According to an embodiment, the provided courier provides the courier associated information to the courier interface device. According to an embodiment, the provided match courier removes the package delivery unit from the holder device and places the package delivery unit on next holder device. According to an embodiment, the holder device further comprises an additional AIDC reader and/or a tag. According to an embodiment, the provided additional AIDC reader and/or a tag uses to recognize courier. According to an embodiment, the provided couriers can be an occasional courier.

According to an embodiment, the provided package delivery unit transferring from holder device to holder device by provided couriers and the provided package delivery unit delivery from initial placed holder device to closets to destination holder device is done in a relay race.

According to an embodiment, the provided holder device controller checking if is current holder device location is closest to package delivery unit destination and notifying destination contact based on destination contact information from package delivery unit associated information. According to an embodiment, the notification to the destination contact can contain an option to self-collecting and can comprise attached AIDC or can contain an option to generate new virtual holder device at destination address.

According to an additional embodiment of the provided method, one of the provided holder device controllers is configured to access the stored databases and identify next holder devices location based on the package delivery unit associated information and at least one courier associated information, and configured to access the stored databases and match at least one of the identify next holder devices location and identified courier interface device and stored routing table, communicate identified courier interface device over the communication network interface and transfer next holder device location. And wherein the others holder device controllers are configured to communicate said controller over the communication network interface and transfer locking position of said package delivery unit, the package delivery unit associated information, and receive command to open the package delivery unit lock. And the courier interface devices being configurated to communicate said one holder device controller over the communication network interface.

According to an additional embodiment of the provided method, providing central management component that can run a database process and delivery management process, and communicate provided holder device controllers and provided courier interface device over the communication network interface; central management component is configured to access the stored databases and identify next holder devices location based on the package delivery unit associated information and at least one courier associated information, and configured to access the stored databases and match at least one of the identify next holder devices location and identified courier interface device and stored routing table, communicate identified courier interface device over the communication network interface and transfer next holder device location. And wherein the holder device controllers are configured to communicate said central management component over the communication network interface and transfer locking position of said package delivery unit, the package delivery unit associated information, and receive command to open the package delivery unit lock. And the courier interface devices being configurated to communicate said central management component over the communication network interface.

According to an embodiment, provided is a delivery method comprising; providing network of holder devices at different location each holder device comprising plurality holding position with locks, RFID readers and controller; providing package delivery units adapted to be held and lock at holder device position and a RFID tag;

providing plurality of couriers with a courier interface device; wherein provided holder device controller can communicating courier interface device for receiving courier current position and destination and matching at least one provided package delivery unit to be transfer to other provided holder device on the route of the provided courier in accordance to routing table; sending suggestion to provided courier interface device to conduct the transfer; receiving confirmation from provided courier interface device for transfer; identifying provided courier interface device and operate locks; and communicating other provided holder device in accordance to routing table on transfer.

According to an additional embodiment of the provided method, further providing a sender, and wherein the sender pleases at least one package delivery unit in a provided holder device. According to an embodiment, the provided package delivery unit route from initial holder device to final holder device comprises at least one additional holder device and the courier transferring is a relay race.

According to an additional embodiment, provided is a computer implemented delivery management system comprising; a network of holder devices at different locations; a package delivery unit; a server; a user interface device; a courier interface device; the holder device having an automatic identification and data capture (AIDC) reader, a lock and a controller having a processor, a memory and a communication network interface; the package delivery unit design to be held and locked by the holder device and having an identification code and AIDC tag; the server having a processor, a memory and a communication network interface; the user interface device having a processor, a memory and a communication network interface;

the courier interface device having a processor, a memory and a communication network interface; the processor and memory on the controller being configurated to retrieve identification information from the AIDC reader, operate the lock, run a database process and communicate the server device over the communication network interface; the processor and memory on the server device being configurated to run database processes and delivery management process and communicate the holder devices controller, the user interface device and the courier interface device over the communication network interface; the processor and memory on the user interface device being configurated to run database process and delivery management process and communicate the server device over the communication network interface; the processor and memory on the courier interface device being configurated to run database process and delivery management process and communicate the server device over the communication network interface; the user interface device being configurated to receive package delivery unit associated information and being configurated to communicate the server device over the communication network interface and transfer the package delivery unit associated information; the server device is configured to store the package delivery unit associated information received from the user interface device; the package delivery unit associated information comprises package delivery unit destination and the package delivery unit identification code; the courier interface device being configurated to receive courier associated information and being configurated to communicate the server device over the communication network interface and transfer the courier associated information; the server device is configured to store the courier associated information received from the courier interface device; the courier associated information comprises courier location, courier destination and courier identification data; the holder device controller is configured to monitor AIDC reader and transfer the package delivery unit identification code to the server device over the communication network interface; the server device is configured to store the package delivery unit identification code and associated holder device received from the holder device controller; the server device is configured to plan routes from the associated holder device location to the package delivery unit destination and to identify holder devices on routes and store the identified holder devices; the server device is configured access the stored databases and match at least one of the identified holder devices, at least one package delivery unit associated information, at least one associated holder device and at least one courier associated information, the server device is configurated to store matches; the server device is configured to execute instruction to open the lock of the associated holder device over the communication network interface if matches at least one of the holder devices on routes;

According to an embodiment, the network of holder devices comprises at least 10 holder devices.

According to an embodiment, the holder device capable to hold and lock more than two package delivery units and capable to associate package delivery unit identification code and holding position on the holder device. According to an embodiment, the holder device is attached to a stand or to a wall.

According to an embodiment, the AIDC is one of an RFID device, NFC device, Smart card device, Barcode device, QR code device and a Magnetic strip device.

According to an embodiment, the AIDC is RFID device.

According to an embodiment, the package delivery unit comprises a box or a bag. According to an embodiment, the package delivery unit comprises a secure, one timer and detectable mark opening.

According to an embodiment, the user interface device has a AIDC reader device. According to an embodiment, the user interface device AIDC reader is a camera or RFID device. According to an embodiment, the user interface device is a computer or a personal mobile device.

According to an embodiment, the courier interface device comprises AIDC reader and/or a tag, and is a computer or a personal mobile device. According to an embodiment, the system further comprising a courier and wherein the courier provides the courier associated information to the courier interface device.

According to an embodiment, the server device is configured to communicate the courier interface device over the communication network interface and transfer the matches associated holder devices and one of the holder devices on route according to courier associated information. According to an embodiment, the courier removes the package delivery units from the associated holder devices and carry to holder device on the route. According to an embodiment, the courier is an occasional courier.

According to an embodiment, the system further comprising a courier and wherein the holder device further comprises an additional AIDC reader and/or a tag.

According to an embodiment, the courier approaches the courier interface device to the additional AIDC reader and/or a tag and the interface device controller or the courier interface device being configured to communicate the server device over the communication network interface and transfer courier associated information. According to an embodiment, the system comprises more than one courier. According to an embodiment, at least part of the couriers a crowd source courier.

According to an embodiment, the system further comprising a sender and wherein the sender provides the package delivery unit associated information to the user interface device. According to an embodiment, the sender put the package delivery unit to holder device.

According to an embodiment, the server device configured to access the stored databases and compare the package delivery unit destination and current associated holder device and configured to generate a massage wherein the package delivery unit reaches closest holder device to the package delivery unit destination and store it in a database. According to an embodiment, the server device configured to access the stored databases, retrieve destination contact information from package delivery unit associated information, retrieve massage and sent it to the destination contact. According to an embodiment, the massage contains an option to self-collecting and can comprise attached AIDC or generating new virtual holder device at destination address.

According to an embodiment, provided is a computer implemented method for delivery management comprising; providing network of holder devices at different locations; providing package delivery unit; providing server; providing user interface device; providing courier interface device; providing in the holder device an automatic identification and data capture (AIDC) reader, a lock and a controller having a processor, a memory and a communication network interface; providing in the package delivery unit design to be held and locked by the holder device and an identification code and AIDC tag; providing in the server a processor, a memory and a communication network interface; providing in the user interface device a processor, a memory and a communication network interface; providing in the courier interface device a processor, a memory and a communication network interface; running with the processor and memory on the controller a database process, retrieving identification information from the AIDC reader, operating the lock and communicating the server device over the communication network interface; running with the processor and memory on the server device a database processes and delivery management process and communicating the holder devices controller, the user interface device and the courier interface device over the communication network interface; running with the processor and memory on the user interface device a database process and delivery management process and communicating the server device over the communication network interface; running with the processor and memory on the courier interface device a database process and delivery management process and communicating the server device over the communication network interface; receiving with the user interface device a package delivery unit associated information and communicating the server device over the communication network interface and transferring the package delivery unit associated information; receiving and storing on the server device the package delivery unit associated information from the user interface device; the package delivery unit associated information comprises package delivery unit destination and the package delivery unit identification code; receiving with the courier interface device a courier associated information and communicating the server device over the communication network interface and transferring the courier associated information; receiving and storing on the server device the courier associated information from the courier interface device; the courier associated information comprises courier location, courier destination and courier identification data; monitoring with the holder device controller the AIDC reader and transferring the package delivery unit identification code to the server device over the communication network interface; receiving and storing on the server device the package delivery unit identification code and associated holder device from the holder device controller; planning routs on the server device from the associated holder device location to the package delivery unit destination, identifying holder devices on routes and storing the identified holder devices; accessing the stored databases on the server device and matching at least one of the identified holder devices, at least one package delivery unit associated information, at least one associated holder device and at least one courier associated information, and storing on the server device matches; executing instructions with the server device to open the lock of the associated holder device over the communication network interface if matches at least one of the holder devices on routes;

According to an embodiment, the provided network of holder devices comprises at least 10 holder devices.

According to an embodiment, the provided holder device capable to hold and lock more than two package delivery units and capable to associate package delivery unit identification code and holding position on the holder device. According to an embodiment, the provided holder device is attached to a stand or to a wall.

According to an embodiment, the provided AIDC is one of an RFID device, NFC device, Smart card device, Barcode device, QR code device and a Magnetic strip device. According to an embodiment, the provided AIDC is RFID device.

According to an embodiment, the provided package delivery unit comprises a box or a bag. According to an embodiment, the provided package delivery unit comprises a secure, one timer and detectable mark opening.

According to an embodiment, the provided user interface device has an AIDC reader device. According to an embodiment, the provided user interface device AIDC reader is a camera or

RFID device. According to an embodiment, the provided user interface device is a computer or a personal mobile device.

According to an embodiment, the provided courier interface device comprises a AIDC reader and/or a tag, and is a computer or a personal mobile device.

According to an embodiment, the method further providing a courier and wherein the courier provides the courier associated information to provided courier interface device.

According to an embodiment, the provided server device communicating and transferring the matches associated holder devices and one of the holder devices on route according to courier associated information.

According to an embodiment, the provided courier removing provided package delivery units from the associated holder devices and carrying to holder device on the route. According to an embodiment, the provided courier is an occasional courier.

According to an embodiment, the method further providing a courier and wherein provided holder device further comprises an additional AIDC reader and/or a tag. According to an embodiment, the provided courier approaches provided courier interface device to the additional AIDC reader and/or a tag and provided interface device controller or provided courier interface device communicating provided server device over the communication network interface and transferring courier associated information. According to an embodiment, the method comprises more than one courier. According to an embodiment, at least part of the provided couriers is crowd source courier.

According to an embodiment, the method further providing a sender and wherein the sender provides the package delivery unit associated information to the user interface device. According to an embodiment, the provided sender put the package delivery unit to holder device. According to an embodiment, the provided server device accessing the stored databases and compering the package delivery unit destination and current associated holder device and configured and generating a massage when provided package delivery unit reaches closest holder device to the package delivery unit destination and storing it in a database. According to an embodiment, the provided server device accessing the stored databases, retrieving destination contact information from package delivery unit associated information, retrieving massage and sending it to the destination contact. According to an embodiment, the provided massage contains an option to self-collecting and can comprise AIDC or generating new virtual holder device at destination address.

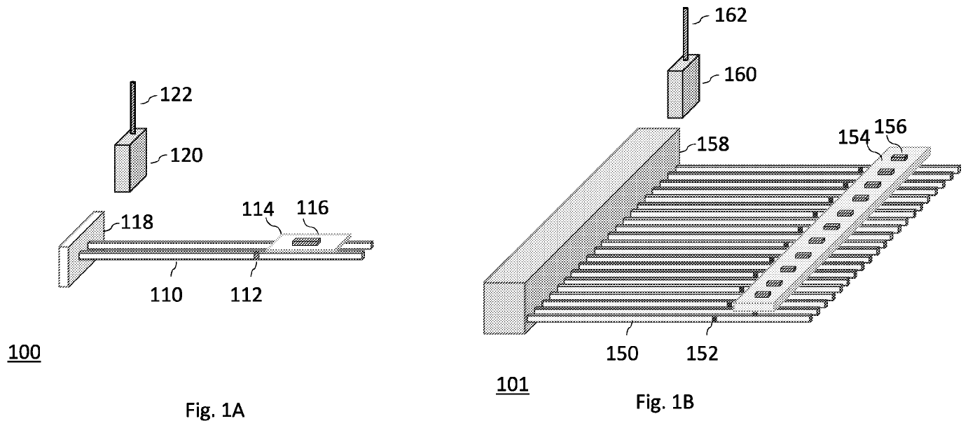

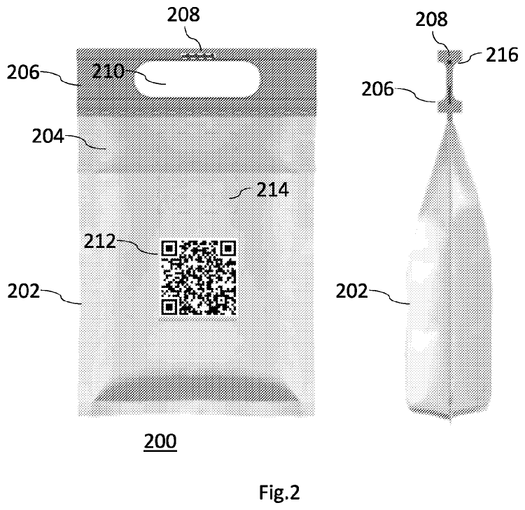

Referring now to the drawings, wherein like reference numerals designate identical or corresponding parts throughout the several views, and more particularly to FIG. 1A thereof, shows an illustrative embodiment of exemplary holder device 100, consist of two bars 110 and supporting base 118. The bars 110 can hold an exemplary package delivery unit (FIG. 2) and connected to supporting base 118 that can be attached to a wall, stand or any other installation. A lock 112 can lock the exemplary package delivery unit when put into the holder device. An automatic identification and data capture (AIDC) reader 116 supported by plate 114 that is connected to holding bars 110. According to embodiment of this invention the AIDC reader 116 is one of an RFID reader, NFC reader, Bluetooth reader, Smart card reader, Barcode scanner, QR code scanner, Camera and a Magnetic strip reader. According to a preferred embodiment the AIDC reader 116 is a RFID reader. A controller 120 with a communication network interface and antenna 122 control the operation of lock 112 and AIDC reader 116. In some embodiments the connection between controller 120, lock 112 and AIDC reader 116 is wireless.

the term AIDC as used herein and through the description refers to an Automatic identification and data capture a method and devices of automatically identifying objects collecting data about them and transferring the collected data in a digital format without human involvement.

FIG. 1B shows an illustrative embodiment of exemplary holder device 101, holder device based on holder device 100 with capability to hold, identify and lock more than one exemplary package delivery unit. the exemplary holder device 101 consist of bars 150 and supporting base 158. The bars 150 can hold an exemplary package delivery unit (FIG. 2) and connected to supporting base 158 that can be attached to a wall, stand or any other installation. Locks 152 can lock the exemplary package delivery units when put into the holder device. An automatic identification and data capture (AIDC) readers 156 supported by plate 154 that is connected to holding bars 150. According to embodiment of this invention the AIDC reader 156 is one of an RFID reader, NFC reader, Bluetooth reader, Smart card reader, Barcode scanner, QR code scanner, Camera and a Magnetic strip reader. According to a preferred embodiment the AIDC reader 156 is a RFID reader. A controller 160 with a communication network interface and antenna 162 control the operation of locks 152 and AIDC readers 156. In some embodiments the connection between controller 160, locks 152 and AIDC readers 156 is wireless.

FIG. 2 shows an illustrative front and side view of exemplary package delivery unit 200. The exemplary package delivery unit 200 consists bag 202 and a handle 206, bag 202 has an opening to enter parcels and a closure 204 that can have double sided adhesive strip (not shown) to secure closer 204 to bag 202 after parcels has inserted into bag 202. exemplary package delivery unit 200 can comprise an identify QR code 212, that can be replaced on marks 214 as opening security. Handle 206 can have an opening 210 for carrying and locking, margins 216 to support and hold package delivery unit and AIDC tag 208. According to embodiment of this invention the AIDC tag 208 is one of an RFID tag, NFC tag, Bluetooth, Smart card tag, Barcode mark, QR code mark and a Magnetic strip. According to a preferred embodiment the AIDC tag 208 is a RFID tag. According to some embodiment the bag 202 consist a metal wire or metal net. According to some embodiment the bag 202 is opaque.

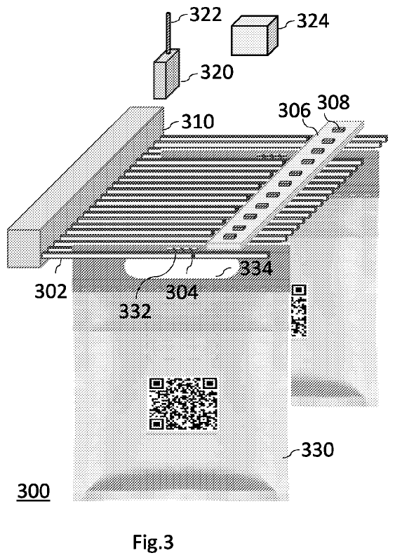

FIG. 3 shows an illustrative perspective view of holder device (FIG. 1A) and package delivery units (FIG. 2), in accordance with exemplary embodiment of present invention. A package delivery unit 330 hold by bars 302. lock 304 prevent removing package delivery unit 330. Lock 304 can comprise a pin going the urge opening 334 and controlled by holder device controller 320. Relevant AIDC reader 308 supported by plate 306 read the package delivery unit AIDC tag 332 and transfer data to controller 320. According to some embodiment the connection of controller 320, locks 304 and AIDC readers 308 is wireless. The holder device can be attached by supporting 310 to a wall or connected to stand or pillars or placed in a cabin. The holder device can comprise additional AIDC device 324, the additional AIDC device 324 is one of an RFID device, NFC device, Bluetooth device, Camera, Smart card device, Barcode device, QR code device and a Magnetic strip device and can be connected to holder device controller 320. In accordance to some embodiment the AIDC device 324 is wireless connected to controller 320.

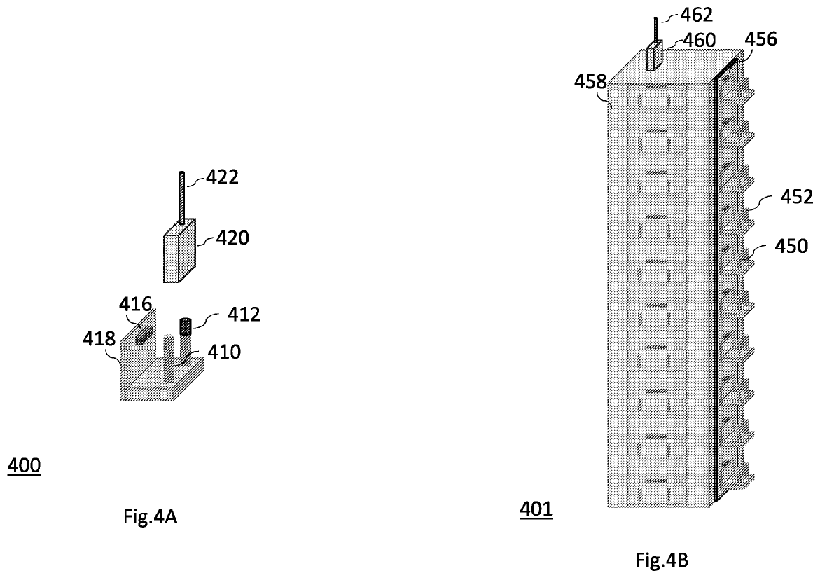

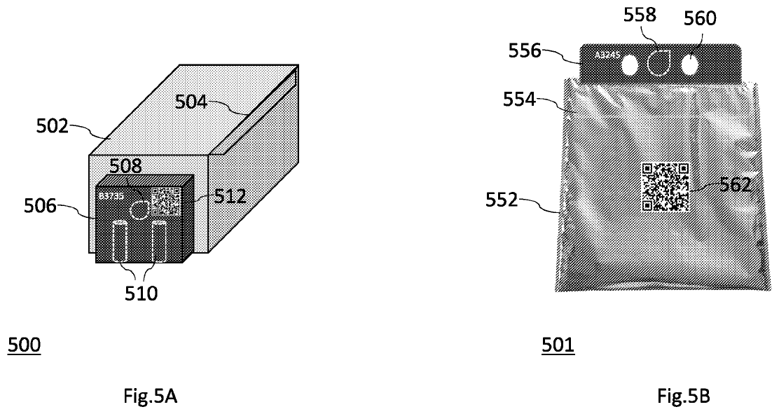

FIG. 4A, shows an illustrative embodiment of another exemplary holder device 400, consist of two bars 410 and supporting base 418. The bars 410 can hold another exemplary package delivery unit (FIG. 5) and connected to supporting base 418 that can be attached to a wall, stand or any other installation. A lock 412 can lock the exemplary package delivery unit when put into the holder device. An automatic identification and data capture (AIDC) reader 416 is connected supporting base 418. According to embodiment of this invention the AIDC reader 416 is one of an RFID reader, NFC reader, Bluetooth reader, Smart card reader, Barcode scanner, QR code scanner, Camera and a Magnetic strip reader. According to a preferred embodiment the AIDC reader 416 is a RFID reader. A controller 420 with n communication network interface and antenna 422 control the operation of lock 412 and AIDC reader 416. In some embodiments the connection between controller 420, lock 412 and AIDC reader 416 is wireless.

FIG. 4B shows an illustrative embodiment of another exemplary holder device 401, holder device based on holder device 400 with capability to hold, identify and lock more than one exemplary package delivery unit. the exemplary holder device 401 consist of bars 450 and supporting base 458. The bars 450 can hold an exemplary package delivery unit (FIG. 5) and connected to supporting base 458 that can be attached to a wall, stand or any other installation. Locks 452 can lock the exemplary package delivery units when put into the holder device. An automatic identification and data capture (AIDC) readers 456 supported by supporting base 458. According to embodiment of this invention the AIDC reader 456 is one of an RFID reader, NFC reader, Bluetooth reader, Smart card reader, Barcode scanner, QR code scanner, Camera and a Magnetic strip reader. According to a preferred embodiment the AIDC reader 456 is a RFID reader. A controller 460 with a communication network interface and antenna 462 control the operation of locks 452 and AIDC readers 456. In some embodiments the connection between controller 460, locks 452 and AIDC readers 456 is wireless.

FIG. 5a and FIG. 5B shows an illustrative another exemplary package delivery units. The exemplary package delivery unit 500 consists box 502 and a unit 506, box 502 has an opening to enter parcels and a closure 504 that can have double sided adhesive strip (not shown) to secure closer 504 to box 502 after parcels has inserted into box 502. exemplary package delivery unit 500 can comprise an identify QR code 512. unit 506 can have a drill 510 for holding and locking and AIDC tag 508. According to embodiment of this invention the AIDC tag 508 is one of an RFID tag, NFC tag, Bluetooth, Smart card tag, Barcode mark, QR code mark and a Magnetic strip. According to a preferred embodiment the AIDC tag 508 is a RFID tag. According to some embodiment the box 502 consist a metal wire or metal net. According to some embodiment the box 502 is opaque. The exemplary package delivery unit 501 consists bag 552 and a handle 556, bag 552 has an opening to enter parcels and a closure 554 that can have double sided adhesive strip (not shown) to secure closer 554 to bag 552 after parcels has inserted into bag 552. exemplary package delivery unit 501 can comprise an identify QR code 562. handle 556 can have an opening 560 for holding and locking and AIDC tag 558. According to embodiment of this invention the AIDC tag 558 is one of an RFID tag, NFC tag, Bluetooth, Smart card tag, Barcode mark, QR code mark and a Magnetic strip. According to a preferred embodiment the AIDC tag 558 is a RFID tag. According to some embodiment the bag 552 consist a metal wire or metal net. According to some embodiment the bag 552 is opaque.

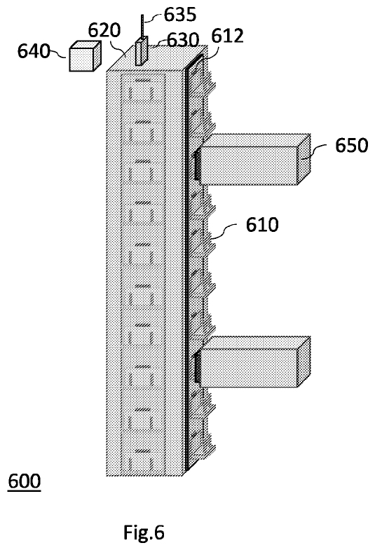

FIG. 6 shows an illustrative perspective view of holder device (FIG. 4A) and package delivery units (FIG. 5A), in accordance with exemplary embodiment of present invention. A package delivery unit 650 is hold and lock by bars 610 and lock 452 (not shown). lock prevent removing package delivery unit 6500. Relevant AIDC reader 612 read the package delivery unit AIDC tag and transfer data to controller 630. According to some embodiment the connection of controller 6300, locks and AIDC readers 612 is wireless. The holder device can be attached by supporting 620 to a wall or connected to stand or pillars or placed in a cabin. The holder device can comprise additional AIDC device 640, the additional AIDC device 640 is one of an RFID device, NFC device, Bluetooth device, Camera, Smart card device, Barcode device, QR code device and a Magnetic strip device and can be connected to holder device controller 320. In accordance to some embodiment the AIDC device 640 is wireless connected to controller 630.

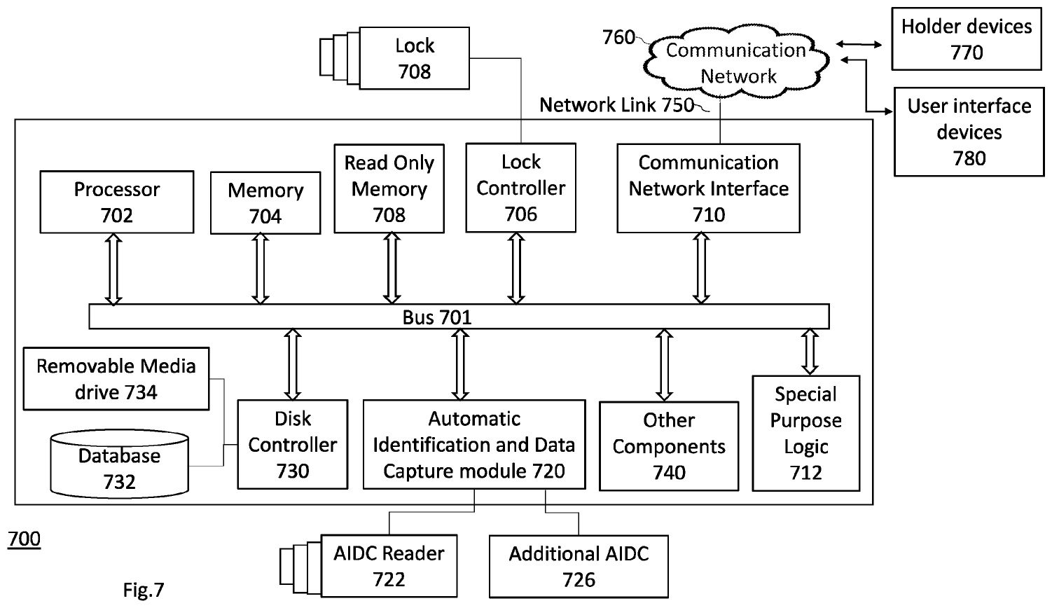

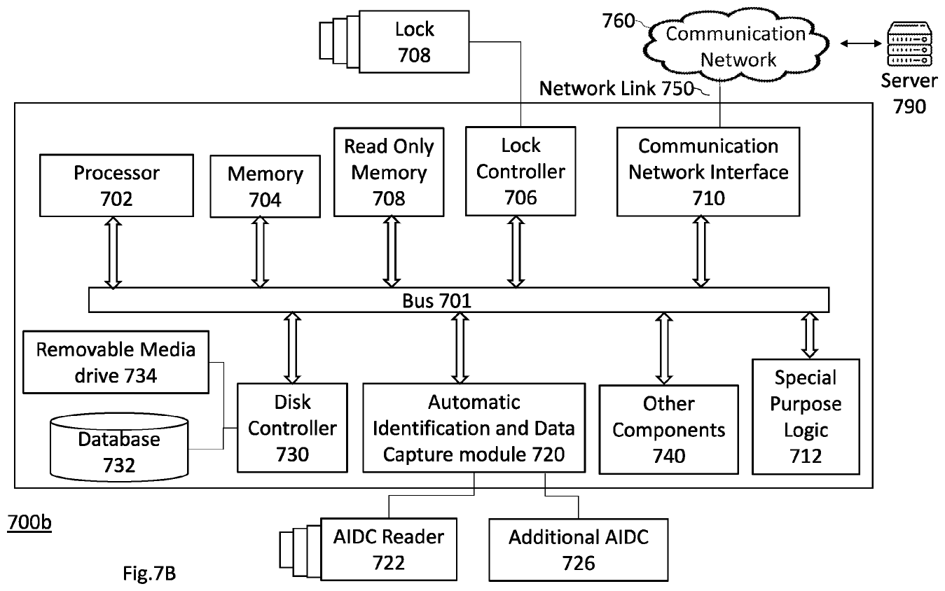

FIG. 7 shows an illustrative holder device controller 700 that control the operation of holder devices shown in FIG. 1, FIG. 3, FIG. 4 and FIG. 6. The controller can be communicating with other holder device controller and users interface device by communication network, sending and receiving data. The controller 700 can include a bus 701 or other communication mechanism for communicating information, and a processor 702 coupled to the bus 701 for processing the information. The controller 800 can also include a memory 704, such as a random-access memory (RAM), other dynamic storage device (e.g., dynamic RAM (DRAM), static RAM (SRAM), synchronous DRAM (SDRAM), flash memory), etc., coupled to the bus 701 for storing information and instructions to be executed by the processor 702.

In addition, the memory 704 can also be used for storing temporary variables or other intermediate information during the execution of instructions by the processor 702. The controller 700 can further include a read only memory 708 or other static storage device (e.g., programmable ROM (PROM), erasable PROM (EPROM), electrically erasable PROM (EEPROM), etc.) coupled to the bus 701 for storing static information and instructions.

The controller 700 can also include a disk controller 730 coupled to the bus 701 to control one or more storage devices for storing information and instructions, such as a magnetic hard disk 732, and a removable media drive 734 (e.g., USB memory card drive, SD card drive, floppy disk drive, read-only compact disc drive, read/write compact disc drive, tape drive, and removable magneto-optical drive). The storage devices can be added to the controller 700 using an appropriate device interface (e g, small computer system interface (SCSI), integrated device electronics (IDE), enhanced-IDE (EIDE), direct memory access (DMA), ultra-DMA), universal serial bus (USB), Firewire (IEEE 1394), or Bluetooth (IEEE 802.15.1).

The controller 700 can also include special purpose logic devices 712, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, communications functions, etc.

The controller 700 can perform one or more processing steps of the invention in response to the processor 702 executing one or more sequences of one or more instructions contained in a memory, such as the memory 704. Such instructions can be read into the memory 704 from another computer readable medium, such as the hard disk 732 or the removable media drive 734. Execution of the arrangement of instructions contained in the memory 704 causes the processor 702 to perform the process steps described herein. One or more processors in a multiprocessing arrangement also can be employed to execute the sequences of instructions contained in the main memory 704. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the controller 700, for driving a device or devices for implementing the invention. Such software can include, but is not limited to, device drivers, firmware, operating systems, development tools, applications software, etc. Such computer readable media can further include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The controller 700 also can include a communication interface 710 coupled to the bus 701. The communication interface 710 can provide a two-way data communication coupling to a network link 750 that is connected to a communications network such as, for example, a local area network (LAN), a wide area network (WAN), a general packet radio service (GPRS), a global packet data communications network, such as the Internet, etc. For example, the communication interface 710 can include a digital subscriber line (DSL) card or modem, a cable modem, a telephone modem, etc., to provide a data communication connection to a corresponding type of telephone line. As another example, the communication interface 710 can include a local area network (LAN) card (e.g., for Ethernet, etc.), etc., to provide a data communication connection to a compatible LAN. Wireless links can also be implemented. In any such implementation, the communication interface 710 can send and receive electrical, electromagnetic, or optical signals that carry digital data streams representing various types of information. Further, the communication interface 710 can include peripheral interface devices, such as a Universal Serial Bus (USB) interface, a PCMCIA (Personal Computer Memory Card International Association) interface, etc.

The network link 750 typically can provide data communication through one or more networks to other data devices. For example, the network link 750 can provide a connection through the communications network 760 to other holder devices controllers 770 or/and to user personal devices 780 or/and in accordance to some embodiments to a server 790 (as shown on FIG. 7B). The communications network 760 can employ electrical, electromagnetic, or optical signals to convey information and instructions. The signals through the various networks and the signals on the network link 750 and through the communication interface 710, which communicate digital data with controller 700, are exemplary forms of carrier waves bearing the information and instructions.

The controller 700 can send messages and receive data, including program code, through the communications network 760, the network link 750, and the communication interface 710. In the Internet example, a server, a personal device or other holder device controller can transmit requested code belonging to an application program for implementing an embodiment of the present invention through communications network 760 and the communication interface 710. The processor 702 can execute the transmitted code while being received and/or store the code in the storage devices 704 or 732, or other non-volatile storage for later execution. In this manner, controller 700 can obtain application code in the form of a carrier wave.

The controller 700 can include Automatic Identification and Data Capture (AIDC) module 720 coupled to the bus 701 and connected to a AIDC reader 722. AIDC reader 722 is one of an RFID device, NFC device, Bluetooth device, Camera, Smart card device, Barcode device, QR code device and a Magnetic strip device. in some embodiment of the invention the AIDC module control and connected to more than one AIDC reader. According to embodiment of the invention the AIDC reader 722 read the package delivery unit AIDC tag. According to some embodiment the controller 700 send to other holder devices through communications network 760 and the communication interface 710 the data read by the AIDC reader 722. At some preferred embodiments the data send by the controller 700 comprises data read by the AIDC reader 722 and the specific position in the holder device. According to some embodiment of the invention additional AIDC device is connected to the AIDC module.

The controller 700 can include lock controller 706 coupled to the bus 701. The lock controllers 706 control the operation of lock 708. Lock 708 lock the package delivery unit when it placed in the holder device. According to embodiments of present invention lock operation is conducted by orders or comments of the controller 700. The operation comment can include open or close to the lock controller 706, according to some embodiment of present invention the lock 708 is a solenoid latch lock and the operation command is open only.

According to embodiments of present invention the holder device contain more than one holding point, lock controller 706 controls at least one lock 708. According to preferred embodiments of present invention the holder device contains more than one holding point, lock controller 706 controls multiply locks 708 associated to holding locations.

The term “computer readable medium” as used herein can refer to any medium that participates in providing instructions to the processor 702 for execution. Such a medium can take many forms, including but not limited to, non-volatile media, volatile media, transmission media, etc. Non-volatile media can include, for example, optical or magnetic disks, magneto-optical disks, etc., such as the hard disk 732 or the removable media drive 734. Volatile media can include dynamic memory, etc., such as the memory 704. Transmission media can include coaxial cables, copper wire and fiber optics, including the wires that make up the bus 8701. Transmission media can also take the form of acoustic, optical, or electromagnetic waves, such as those generated during radio frequency (RF) and infrared (IR) data communications.

As stated above, the controller 700 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to communications network 760. In such a scenario, the remote computer can load the instructions into memory and send the instructions, for example, over a telephone line using a modem.

FIG. 7B shows an illustrative holder device controller 700b in accordance to some embodiments, the system further comprises a central management connected to the system via the communication network 750. According to some embodiments the central management system is a server connected to the communication network or a clued server.

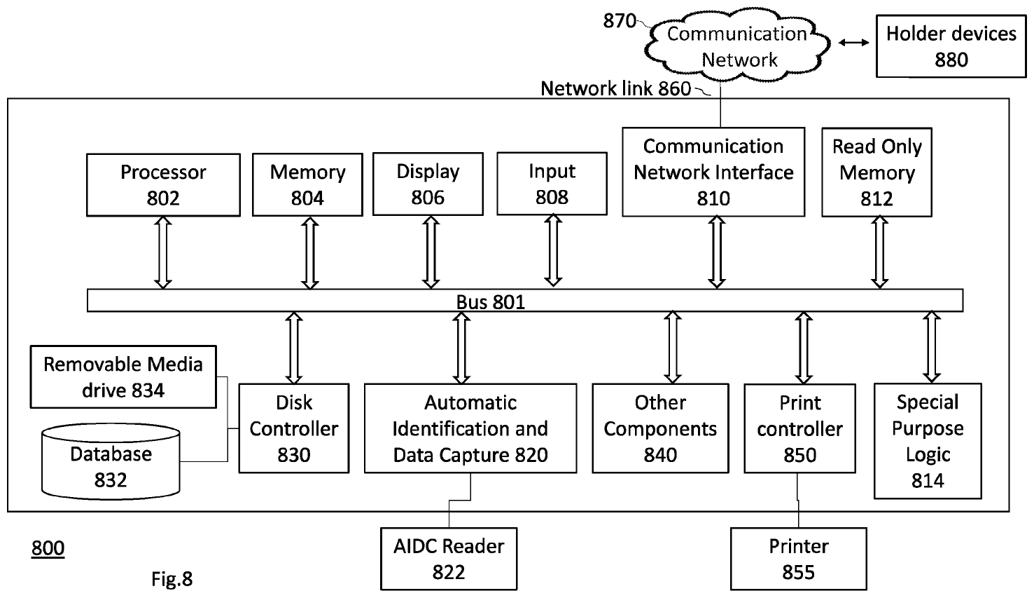

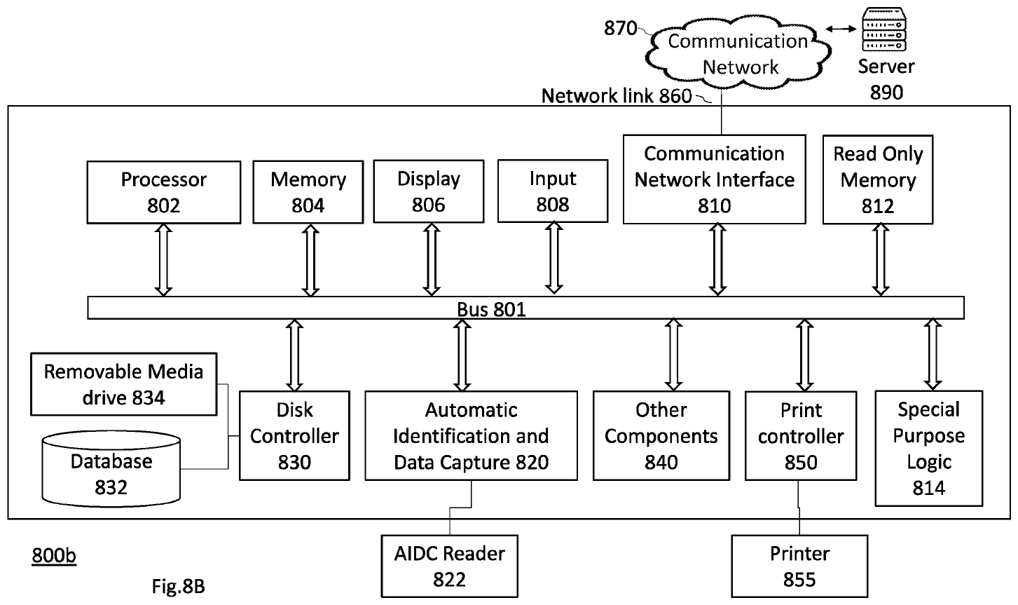

FIG. 8 shows an illustrative example of computer system that can be used to preform various process by users, in accordance with exemplary embodiment of present invention. According to embodiments of present invention computer system can used as users (senders, couriers and recipients) interface device to the system. According to some embodiments the computer system is a personal device and can be any one of personal computer, tablet, laptop, smart phone, Smart watch or other electronic computer device that can perform tasks needed for interfacing the system. The computer system 800 can include a bus 801 or other communication mechanism for communicating information, and a processor 802 coupled to the bus 801 for processing the information. The computer system 800 can also include a memory 804, such as a random-access memory (RAM), other dynamic storage device (e.g., dynamic RAM (DRAM), static RAM (SRAM), synchronous DRAM (SDRAM), flash memory), etc., coupled to the bus 801 for storing information and instructions to be executed by the processor 802.

In addition, the memory 804 can also be used for storing temporary variables or other intermediate information during the execution of instructions by the processor 802. The computer system 800 can further include a read only memory 812 or other static storage device (e.g., programmable ROM (PROM), erasable PROM (EPROM), electrically erasable PROM (EEPROM), etc.) coupled to the bus 801 for storing static information and instructions.

The computer system 800 can also include a disk controller 830 coupled to the bus 801 to control one or more storage devices for storing information and instructions, such as a magnetic hard disk 832, and a removable media drive 834 (e.g., USB memory card drive, SD card drive, floppy disk drive, read-only compact disc drive, read/write compact disc drive, tape drive, and removable magneto-optical drive). The storage devices can be added to the computer system 800 using an appropriate device interface (e.g., small computer system interface (SCSI), integrated device electronics (IDE), enhanced-IDE (EIDE), direct memory access (DMA), ultra-DMA), universal serial bus (USB), Firewire (IEEE 1394), or Bluetooth (IEEE 802.15.1).

The computer system 800 can also include special purpose logic devices 814, such as application specific integrated circuits (ASICs), full custom chips, configurable logic devices (e.g., simple programmable logic devices (SPLDs), complex programmable logic devices (CPLDs), field programmable gate arrays (FPGAs), etc.), etc., for performing special processing functions, such as signal processing, image processing, speech processing, voice recognition, communications functions, etc.

The computer system 800 also can include a display 806 coupled to the bus 820, such as a cathode ray tube (CRT), liquid crystal display (LCD), active matrix display, plasma display, touch display, etc., for displaying or conveying information to a computer user. The computer system can include input 808 devices, such as a keyboard including alphanumeric and other keys and a pointing device, for interacting with a computer user and providing information to the processor 802. The pointing device can include, for example, a mouse, a trackball, a pointing stick, etc., or voice recognition processor, etc., for communicating direction information and command selections to the processor 802 and for controlling cursor movement on the display 806. In addition, a printer controller 850 can be connected to a printer 855 that can provide printed data structures/information of the systems and methods of the present invention or any other data stored and/or generated by the computer system 800.

The computer system 800 can perform one or more processing steps of the invention in response to the processor 802 executing one or more sequences of one or more instructions contained in a memory, such as the memory 804. Such instructions can be read into the memory 804 from another computer readable medium, such as the hard disk 832 or the removable media drive 834. Execution of the arrangement of instructions contained in the memory 804 causes the processor 802 to perform the process steps described herein. One or more processors in a multiprocessing arrangement also can be employed to execute the sequences of instructions contained in the main memory 804. In alternative embodiments, hard-wired circuitry can be used in place of or in combination with software instructions. Thus, embodiments are not limited to any specific combination of hardware circuitry and/or software.

Stored on any one or on a combination of computer readable media, the embodiments of the present invention can include software for controlling the computer system 800, for driving a device or devices for implementing the invention, and for enabling the computer system 800 to interact with a human user (e.g., users of the systems and methods of the present invention, etc.). Such software can include, but is not limited to, device drivers, firmware, operating systems, development tools, applications software, etc. Such computer readable media can further include the computer program product of an embodiment of the present invention for performing all or a portion (if processing is distributed) of the processing performed in implementing the invention. Computer code devices of the embodiments of the present invention can include any interpretable or executable code mechanism, including but not limited to scripts, interpretable programs, dynamic link libraries (DLLs), Java classes and applets, complete executable programs, Common Object Request Broker Architecture (CORBA) objects, etc. Moreover, parts of the processing of the embodiments of the present invention can be distributed for better performance, reliability, and/or cost.

The computer system 800 also can include a communication interface 810 coupled to the bus 801. The communication interface 810 can provide a two-way data communication coupling to a network link 860 that is connected to a communications network such as, for example, a local area network (LAN), a wide area network (WAN), a general packet radio service (GPRS), a global packet data communications network, such as the Internet, etc. For example, the communication interface 810 can include a digital subscriber line (DSL) card or modem, a cable modem, a telephone modem, etc., to provide a data communication connection to a corresponding type of telephone line. As another example, the communication interface 810 can include a local area network (LAN) card (e.g., for Ethernet, etc.), etc., to provide a data communication connection to a compatible LAN. Wireless links can also be implemented. In any such implementation, the communication interface 810 can send and receive electrical, electromagnetic, or optical signals that carry digital data streams representing various types of information. Further, the communication interface 810 can include peripheral interface devices, such as a Universal Serial Bus (USB) interface, a PCMCIA (Personal Computer Memory Card International Association) interface, etc.

The network link 860 typically can provide data communication through one or more networks to other data devices. For example, the network link 860 can provide a connection through the communications network 870 to holder devices 880 or/and in accordance to some embodiments to a server 890 (as shown on FIG. 8B). The communications network 870 can employ electrical, electromagnetic, or optical signals to convey information and instructions. The signals through the various networks and the signals on the network link 870 and through the communication interface 810, which communicate digital data with computer system 800, are exemplary forms of carrier waves bearing the information and instructions.

The computer system 800 can send messages and receive data, including program code, through the communications network 870, the network link 860, and the communication interface 810. In the Internet example, a server can transmit requested code belonging to an application program for implementing an embodiment of the present invention through communications network 870 and the communication interface 810. The processor 802 can execute the transmitted code while being received and/or store the code in the storage devices 804 or 832, or other non-volatile storage for later execution. In this manner, computer system 800 can obtain application code in the form of a carrier wave.

The computer system 800 can include Automatic Identification and Data Capture (AIDC) module 820 coupled to the bus 801 and connected to a AIDC reader 822. AIDC reader 822 is one of an RFID device, NFC device, Bluetooth device, Camera, Smart card device, Barcode device, QR code device and a Magnetic strip device.

The term “computer readable medium” as used herein can refer to any medium that participates in providing instructions to the processor 802 for execution. Such a medium can take many forms, including but not limited to, non-volatile media, volatile media, transmission media, etc. Non-volatile media can include, for example, optical or magnetic disks, magneto-optical disks, etc., such as the hard disk 832 or the removable media drive 834. Volatile media can include dynamic memory, etc., such as the memory 806. Transmission media can include coaxial cables, copper wire and fiber optics, including the wires that make up the bus 801. Transmission media can also take the form of acoustic, optical, or electromagnetic waves, such as those generated during radio frequency (RF) and infrared (IR) data communications.

As stated above, the computer system 800 can include at least one computer readable medium or memory for holding instructions programmed according to the teachings of the invention and for containing data structures, tables, records, or other data described herein. Common forms of computer-readable media can include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media can be involved in providing instructions to a processor for execution. For example, the instructions for carrying out at least part of the embodiments of the present invention can initially be borne on a magnetic disk of a remote computer connected to communications network 870. In such a scenario, the remote computer can load the instructions into memory and send the instructions, for example, over a telephone line using a modem.

FIG. 8B shows an illustrative computer system 800b, in accordance to some embodiments, the system further comprises a central management connected to the system via the communication network 870. According to some embodiments the central management system is a server connected to the communication network or a clued server.

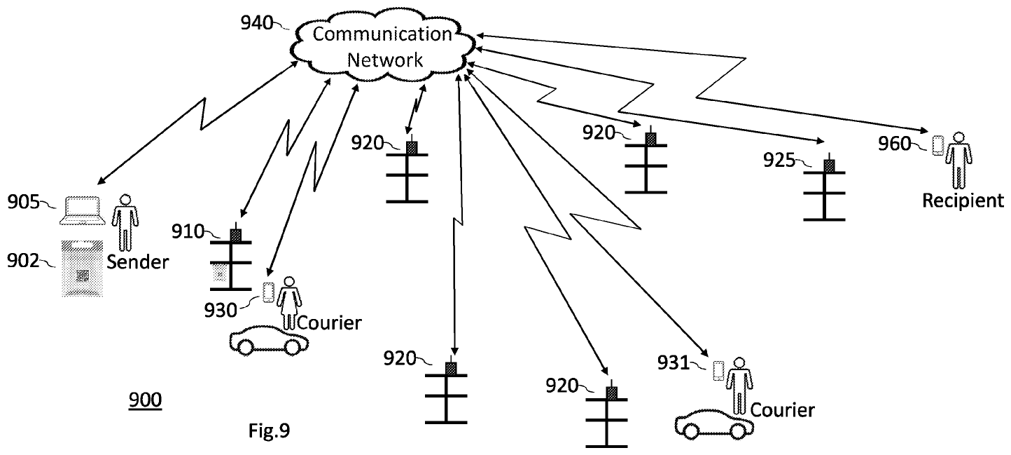

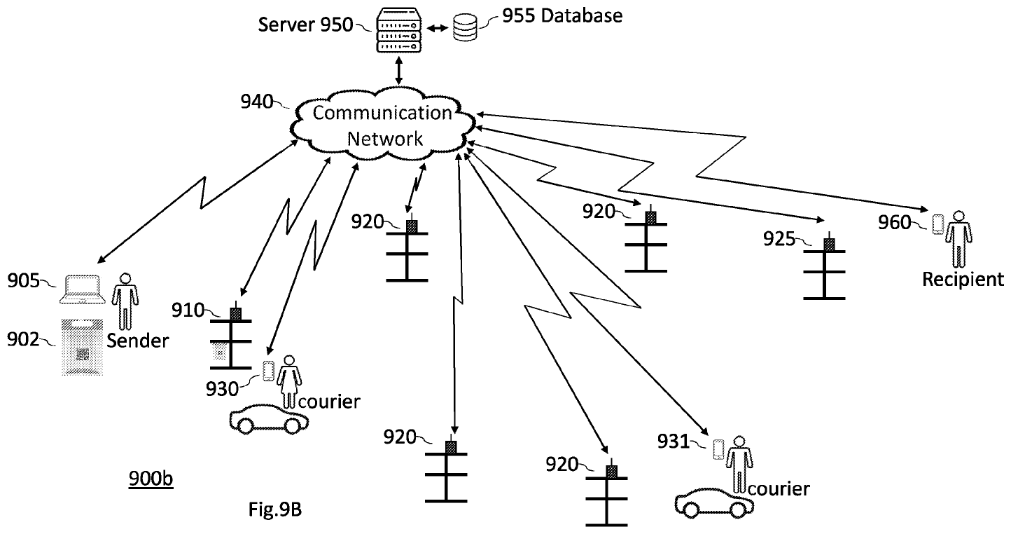

FIG. 9 shows an illustrative delivery system and method 900, in accordance with exemplary embodiment of present invention. The delivery system comprises a net of holder devices 910, 920, 925 (for example FIG. 3) located at different locations. Holder devices 910, 920, 925 are the identical functions holder devices and the different numbering is for sake of explanation only. The holder devices can appear at various installations; installation on a wall, as a designated stand, inside a pillar or a cabin etc. according to the needs of the specific location. According to present invention different location refer to a place that is remote from other location (for example, Newark N.J. and Albany N.Y., different locations inside specific city and different location along the roads between cites). Holder devices 920 can be placed in any location that provide unlimited users accesses and can include: Gas station, train stations, underground station, Air ports, Convenience stores, Fast food and Coffee shops, Business centers and Streets.

Getting back to FIG. 9, The delivery system and method 900 comprises a net of holder devices 910, 920, 925 at different locations and connected via communication network 940. The delivery system can comprise a personal device shown in FIG. 9 of the users of the system and method (e.g., personal device 905 of a sender, personal device 930, 931 of couriers, personal device 960 of a recipient, etc.) communicating with the holder devices over communications network 940 (e.g., a wired and/or wireless communications network). The personal devices can be configured to provide access to the system and method by individual users and allow the users to conveniently and securely perform operations. The personal devices can include, for example, a processor, a data storage device, a user interface, and/or a security mechanism, and the like. The personal devices can communicate with server device via the communications network 940. The personal device can be any computing device as specify in of FIG. 8 description.

The delivery system and method can comprise a sender at least one courier. The sender, provided with a package delivery unit 902 uses user interface software on his personal device 905 to provide the recipient data and address and can scan with personal device 905 AIDC device the identification tag on the package delivery unit 902. The combine data, the package delivery unit associated data (sender data, recipient data and address and package delivery unit identification tag data) transfer from the sender personal device 905 via communication network 940 to holder device 910. According to some embodiments of present invention the providing of package delivery unit associated data can be made automatedly based on data stored in sender personal device 905 or data from the holder devices.

The delivery management system of the delivery system and method 900 start the transport process when Package delivery unit 902 is placed in holder device 910. The holder device 910 chosen to be the first for sake of explanation only, but the transport process can start from any holder device 920 and/or 925. When Package delivery unit 902 is placed in holder device 910, holding position AIDC reader read delivery package AIDC tag and holder device controller stored Package delivery unit identification tag data together with holder device specific holding position. The holder device controller (FIG. 7) is configurated to locate at database 732 the delivery package unit associated data and to planed optional transfer route from holder device 910 to the closest holder device on the net to the recipient address. According to some embodiment of invention route planning can be made using routing tables. According to some embodiments the routing tables is on of: Anycast routing, Geographic routing or Hybrid routing. According to preferred embodiments the holder's devices controllers communicates and update routing table in accordance to various aspects. The holder device controller is configured to set available holder devices 920 on the planed transfer route. The holder device controller is configurated to receive from the user's personal devices occasionally courier's current location and destination. The holder device controller is configurated to locate and contact relevant occasionally courier that can transfer package delivery unit 902 from holding device 910 to next in route holding device. occasionally courier is identified by personal device 930 when approaching holding device 910. The holder device controller can send to the courier personal device package delivery unit 902 specific position in holding device 910 and planned next holder device 920 on route data the holder device controller commends to open specific position lock. occasional courier transfers the package delivery unit to next holder device 920. When Package delivery unit 902 is placed in holder device 920, holding position AIDC reader read delivery package AIDC tag and holder device controller stored Package delivery unit identification tag data together with holder device specific holding position. The holder device controller (FIG. 7) is configurated to locate at database 732 the delivery package unit associated data and to planed optional transfer route from holder device 920 to the closest holder device on the net to the recipient address. According to some embodiment of invention route planning can be made using routing tables. The holder device controller is configured to set available holder devices 920 or 925 on the planed transfer route. The holder device controller is configurated to receive from the user's personal devices occasionally courier's current location and destination. The holder device controller is configurated to locate and contact relevant occasionally courier that can transfer package delivery unit 902 from holding device 920 to next in route holding device. occasionally courier is identified by personal device 931 when approaching holding device 920. The holder device controller can send to the courier personal device package delivery unit 902 specific position in holding device 910 and planned next holder device 920 or 925 on route data the holder device controller commends to open specific position lock. occasional courier transfers the package delivery unit to next holder device 920 or 925. The sequence repeat itself until the package delivery unit arrived to the closest holder device 925 to the precipitant (the couriers transfer the package delivery unit in relay race delivery). In some embodiment of current invention, the occasional courier can be a crowed source courier. when package delivery unit 902 reaches holder device 925, the 925 holder device controller sends a notification, based on data provided by sender (package delivery unit associated data) to recipient personal device 960 of arrival of package for him, location of holder device 925, specific position on the holder device and releasing manners.

FIG. 9B shows an illustrative delivery system and method 900b, in accordance to some embodiments, the system further comprises a central management connected to the system via the communication network 940. According to some embodiments the central management system is a server connected to the communication network or a clued server.

on FIG. 9B, the delivery system and method 900b comprises a net of holder devices 910, 920, 925 at different locations and connected via communication network 940 to a server device 950. The Server device is configured to receive data from the holder devices 910, 920, 925 and can store it on Database 955. The server device 950 can execute command to open selected locks on holder devices 910, 920 and 925 In accordance to the delivery system management system. The delivery system can comprise a personal device shown in FIG. 9 of the users of the system and method (e.g., personal device 905 of a sender, personal device 930, 931 of couriers, personal device 960 of a recipient, etc.) communicating with the server 950 over communications network 940 (e.g., a wired and/or wireless communications network). The personal devices can be configured to provide access to the system and method by individual users and allow the users to conveniently and securely perform operations. The personal devices can include, for example, a processor, a data storage device, a user interface, and/or a security mechanism, and the like. The personal devices can communicate with server device via the communications network 940. The personal device can be any computing device as specify in of FIG. 8 description.

The delivery system and method 900b can comprise a sender at least one courier. The sender, provided with a package delivery unit 902 uses user interface software on his personal device 905 to provide the recipient data and address and can scan with personal device 905 AIDC device the identification tag on the package delivery unit 902. The combine data, the package delivery unit associated data (sender data, recipient data and address and package delivery unit identification tag data) transfer from the sender personal device 905 via communication network 940 to server device 950 and can be stored at database 955. According to some embodiments of present invention the providing of package delivery unit associated data can be made automatedly based on data stored in sender personal device 905 or data from the server device 950.

The delivery management system of the delivery system and method 900b start the transport process when Package delivery unit 902 is placed in holder device 910. The holder device 910 chosen to be the first for sake of explanation only, but the transport process can start from any holder device 920 and/or 925. When Package delivery unit 902 is placed in holder device 910, holding position AIDC reader read delivery package AIDC tag and holder device controller send Package delivery unit identification tag data together with holder device specific holding position via communication network 940 to server device 950 and can be stored at database 955. The server device 950 is configurated to locate at database 955 the delivery package unit associated data at the time server device 950 receive the Package delivery unit identification tag data together with holder device specific holding position from holder device 910 and to planed optional transfer route from holder device 910 to the closest holder device on the net to the recipient address. The server device 950 configured to locate available holder devices 920 on the planed transfer route. The server device 950 configurated to receive from the system occasionally courier's current location and destination. The server device configurated to locate and contact relevant occasionally courier that can transfer package delivery unit 902 from holding device 910 to next in route holding device. occasionally courier is identified by personal device 930 when approaching holding device 910 and send the location to server device 950. Server device send to the courier personal device package delivery unit 902 specific position in holding device 910. And send holding device 910 commend to open specific position lock. occasional courier transfers the package delivery unit to next holder device 920 as specify by server device. When Package delivery unit 902 is placed by occasional courier in holder device 920, holding position AIDC reader read delivery package AIDC tag and holder device controller send Package delivery unit identification tag data together with holder device specific holding position via communication network 940 to server device 950 and can be stored at database 955. And the server device 950 locates the next available courier and send to his personal device 931. The sequence repeat itself until the package delivery unit arrived to the closest holder device 925 to the precipitant (the couriers transfer the package delivery unit in relay race delivery). In some embodiment of current invention, the occasional courier can be a crowed source courier. when package delivery unit 902 reaches holder device 925 the server device sends a notification, based on data provided by sender (package delivery unit associated data) to recipient personal device 960 of arrival of package for him, location of holder device 925, specific position on the holder device and releasing manners.

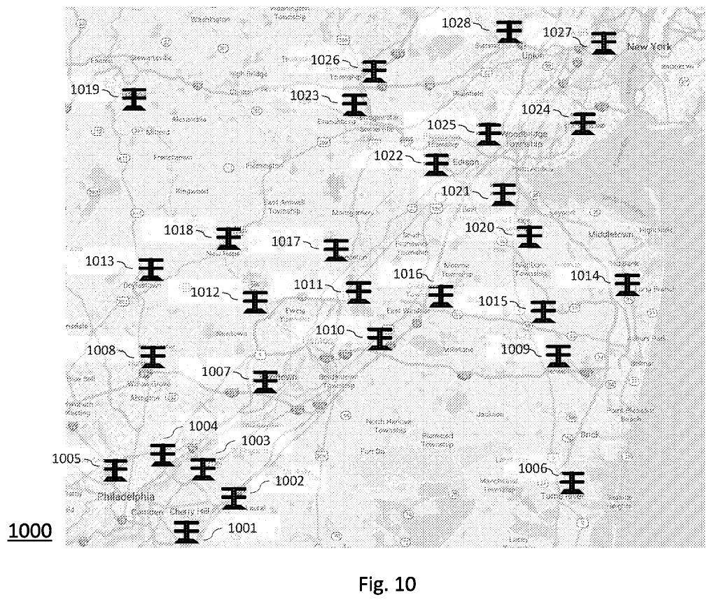

FIG. 10 shows an illustrative deployment of delivery system and method 1000, in accordance with exemplary embodiment of present invention.

On FIG. 10 exemplary deployment of Holder devices in selected area on north east US. The holder devices numbered 1001 to 1028 are placed in available locations as Gas station, train stations, underground station, Air ports, Convenience stores, Fast food and Coffee shops, Business centers and Streets that provide unlimited users accesses.
Optional route of delivery from Philadelphia to New Jersey can be from holder device 1005 to 1004 and then to 1007, 1010, 1016, 1022, 1025 to destination 1027. If for example holder device 1016 is un active, the route can change and from holder device 1010 the delivery can be routed to holder device 1011 then 1017 and from there to 1022.
As can be understand various route can be made from any holder device to other. And planning routes can be made upon various parameters for example: traffic, weather, drivers availability, number of deliveries, traffic jams, holder devices capacity and more.

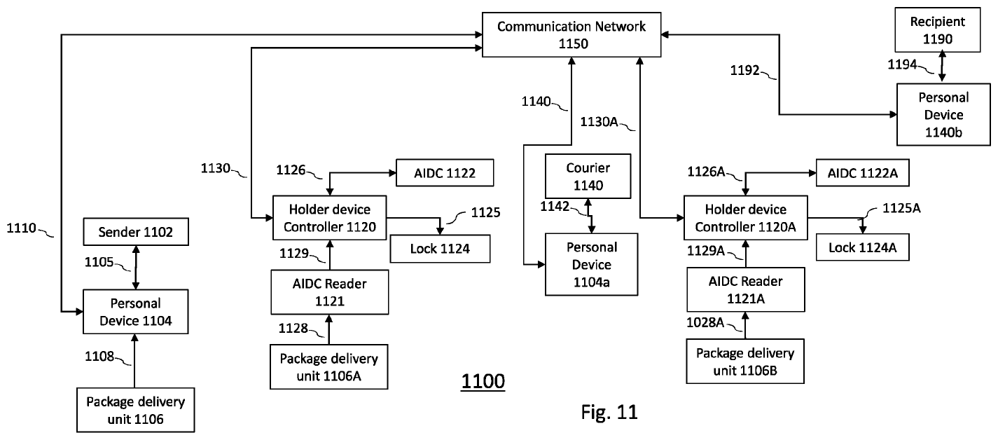

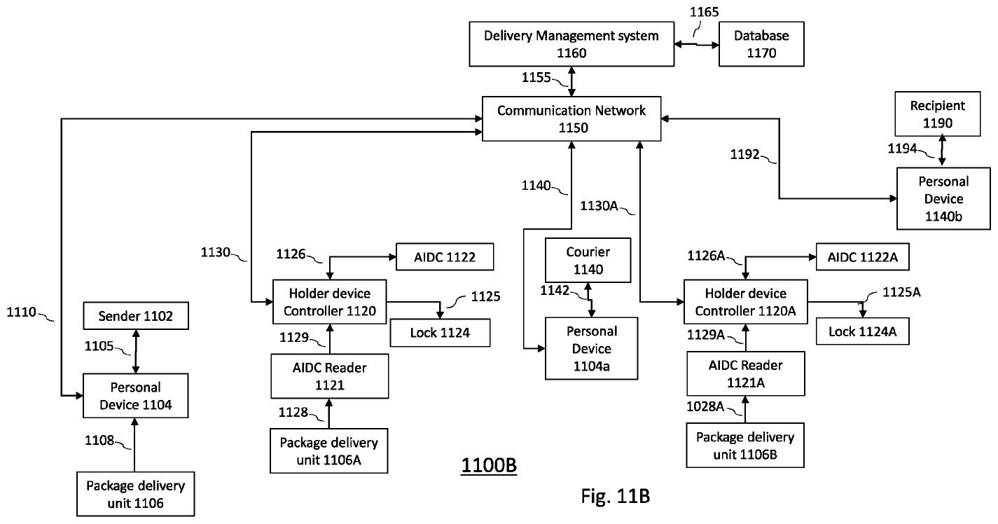

FIG. 11 shows an illustrative delivery system and method 1100, in accordance with exemplary embodiment of present invention. The delivery system comprises personal devices 1104, 1104a, 1104b, holder devices 1120 and 1120A. All connected via communication network 1150. Personal device 1104 provide package delivery unit associated data via communication network 1110 and 1130 to the holder device controller 1120. Package delivery unit associated data provided from sender 1102 and package delivery unit 1106 can comprise sender address and personal data, recipient address and personal data and package delivery unit identification tag data. Holder device controller 1120 can provide sender personal device 1104 data in the delivery process via communication network 1130 and 1110, the data can include package delivery unit 1106 delivery progression and estimations.

holder device controller 1120 stored package delivery unit 1106a (some as 1106 but after placement in holder device 1020) identification tag data and holder device specific holding position of package delivery unit 1106a. In some embodiments of present invention holder device controller 1020 gain courier identification by AIDC 1022. holder device controller 1120 commend to open specific position lock 1024.

personal device 1004a provide courier associated data via communication network 1144 and 1130 to the holder device controller 1120. courier associated data can comprise courier personal data, current location, destination and availability. Holder device controller 1120 can provide courier personal device 1104a data via communication network 1130 and 1140. the data can comprise available package delivery unit to be transfer, location and next holder device location and AIDC tag for identification.

holder device controller 1120a stored package delivery unit 1106b (some as 1106a but after placement in holder device 1020a) identification tag data and holder device specific holding position of package delivery unit 1106b. In some embodiments of present invention holder device controller 1020a gain courier identification by AIDC 1022a. holder device controller 1120a commend to open specific position lock 1024a.

Holder device controller 1120a can provide personal device 1040b data via communication network 1130a and 1092, the Data can comprise delivery progression and estimations, arrival and specific position of package delivery unit 1006 in final holder device and AIDC tag for identification. In some embodiment the data can comprise option for personal delivery.

recipient personal device 1004b can provide confirmation of arrival and feedbacks.

FIG. 11b shows an illustrative delivery system and method 1100b, in accordance with other exemplary embodiment of present invention. The delivery system comprises personal devices 1104, 1104a, 1104b, holder devices 1120 and 1120A and a delivery management 1160. All connected via communication network 1150. Personal device 1104 provide package delivery unit associated data via communication network 1110 and 1155 to the delivery management system 1160, that can be stored at database 1170 via connection 1165.

Package delivery unit associated data provided from sender 1102 and package delivery unit 1106 and can comprise sender address and personal data, recipient address and personal data and package delivery unit identification tag data. Delivery management system 1160 can provide sender personal device 1104 data in the delivery process via communication network 1155 and 1110, the data can include package delivery unit 1106 delivery progression and estimations.

holder device controller 1120 provide package delivery unit 1106a identification tag data and holder device specific holding position of package delivery unit 1106a via communication network 1130 and 1155 to the delivery management system 1160, that can be stored at database 1170 via connection 1165. In some embodiments of present invention holder device controller 1120 gain courier identification by AIDC 1122 and provide courier identification via communication network 1130 and 1155 to the delivery management system 1160, that can be stored at database 1170 via connection 1165. delivery management system 1160 can provide holder device controller 1120 commend to open specific position lock 1124 via communication network 1155 and 1130.

personal device 1104a provide courier associated data via communication network 1144 and 1155 to the delivery management system 1160, that can be stored at database 1170 via connection 1165. courier associated data can comprise courier personal data, current location, destination and availability. Delivery management system 1160 can provide courier personal device 1104a data via communication network 1155 and 1140. the data comprising available package delivery unit to be transfer, location and next holder device location and AIDC tag for identification.

holder device controller 1120a provide package delivery unit 1106b identification tag data and holder device specific holding position of package delivery unit 1106b via communication network 1130A and 1155 to the delivery management system 1160, that can be stored at database 1170 via connection 1165. In some embodiments of present invention holder device controller 1120A gain courier identification by AIDC 1122A and provide courier identification via communication network 1130A and 1155 to the delivery management system 1160, that can be stored at database 1170 via connection 1165. delivery management system 1160 can provide holder device controller 1120A commend to open specific position lock 1124A via communication network 1155 and 1130A.

delivery management system 1160 can provide personal device 1140b data via communication network 1155 and 1192, the data can comprise delivery progression and estimations, arrival and specific position of package delivery unit 1106 in final holder device and AIDC tag for identification. In some embodiment the data can comprise option for personal delivery.

recipient personal device 1104b can provide delivery management system 1160 confirmation of arrival and feedbacks.

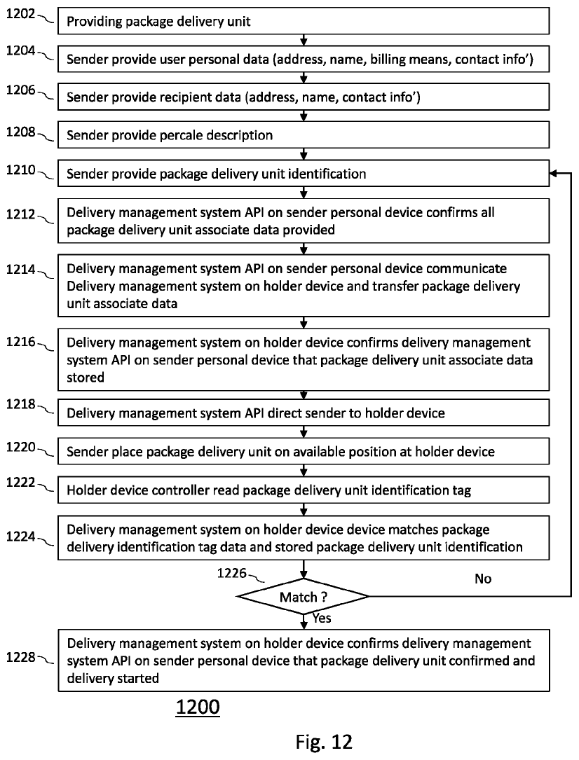

FIG. 12 shows illustrative flowchart of processes performed by a delivery system and method in an exemplary package delivery unit sending procedure. The process starts in providing the package delivery unit 1202 to the sender. The sender provides to the delivery management system API on sender personal device the user (sender) personal data 1204 and recipient data 1206, the user personal data comprises at least the user (sender) address, name, billing means and contact information 1204, the recipient data comprises at least address, name and contact information 1206. The user (sender) can provide percale description 1208. The providing of the data 1204, 1206 and 1208 can be done on the delivery management system API on sender personal device, or by connecting the delivery management system API on sender personal device to the user (sender) database. The user (sender) provide the package delivery unit unique identification 1210, the package delivery unit unique identification can be a numeric/alphabetic code, a QRCODE/BARCODE or an RFID scan tag (representing the same code). The delivery management system API on sender personal device confirms that all the required fields has been filled 1212 and communicate the delivery management system on one of the holder devices and transfer package delivery unit associate data 1214, the package delivery unit associate data comprises at least the package delivery unit identification, recipient address, recipient name, recipient contact information and sender contact information. The delivery management system of the holder device confirms the user (sender) delivery management system API on the reception of the transferred details 1216, then the delivery management system API on sender personal device direct the sender to the available holder device 1218. After the sender place the package delivery unit in available position in the holder device 1220 the holder device read the package unit identification tag 1222 and matches the package unit identification tag with the stored package delivery unit identification code 1224. If the placed package delivery unit code doesn't match the stored package delivery unit 1226 the sender gets a notification that the codes don't match and a re identification process is required. If the placed package delivery unit code matches the stored package delivery unit 1226 the sender gets a notification that the codes match and the delivery process has started 1228. In some embodiment the delivery management system on the holder device send a message to the recipience that the delivery is on the way.

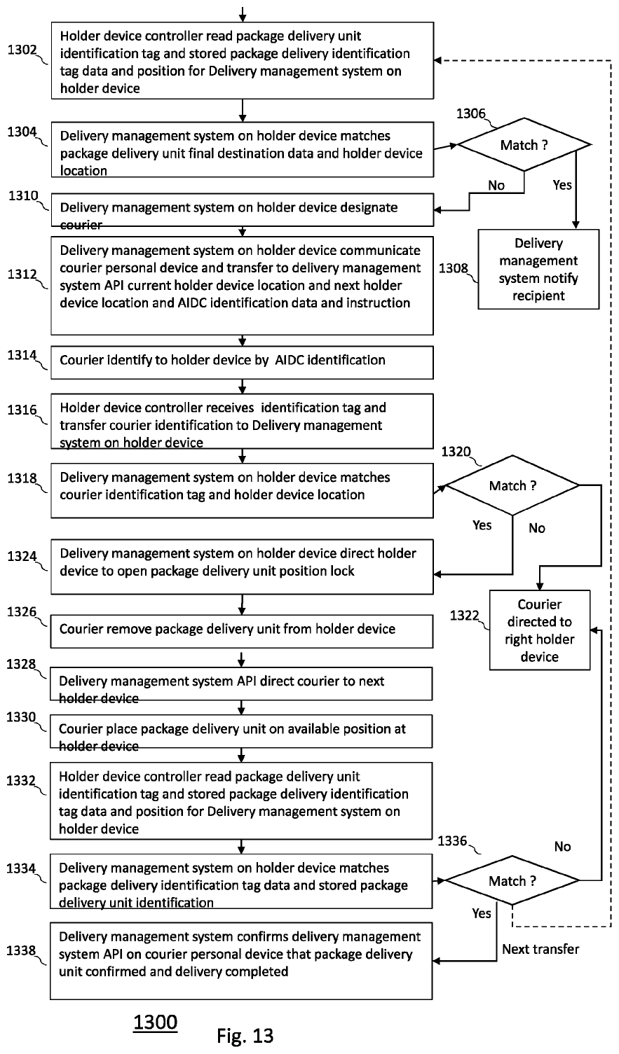

FIG. 13 shows illustrative flowchart of processes performed by a delivery system and method in an exemplary package delivery unit transport procedure. Holder device controller read package delivery unit identification tag and stored package delivery identification tag data and position for Delivery management system on holder device 1302. The delivery management system on holder device matches package delivery unit final destination data and holder device location 1304, if matches 1306 the Delivery management system notify recipient 1308, if not the delivery management system on holder device designate courier 1310. Delivery management system on holder device communicate courier personal device and transfer to delivery management system API current holder device location and next holder device location and AIDC identification data and instruction 1312. Courier identify to holder device by AIDC identification 1314 for arriving at the relevant holder device location. Holder device controller receives identification tag and transfer courier identification to Delivery management system on holder device 1316. Delivery management system on holder device matches courier identification tag and holder device location 1318, if the codes don't match 1320, the Courier directed to right holder device 1322, if the code matches then the delivery management system on holder device direct holder device to open package delivery unit position lock 1324. Courier remove package delivery unit from holder device 1326 and the Delivery management system API direct courier to next holder device 1328. When the courier arrives to the next holder device location the Courier place package delivery unit on available position at holder device 1330. The Holder device controller read package delivery unit identification tag and stored package delivery identification tag data and position for Delivery management system on holder device 1332. The Delivery management system on holder device matches package delivery identification tag data and stored package delivery unit identification 1334, if the codes don't match 1336, the Courier directed to right holder device 1322, if the code matches then the Delivery management system confirms delivery management system API on courier personal device that package delivery unit confirmed and current delivery completed 1338. The process 1300 re start for the next transfer when the Delivery management system confirms delivery management system API on courier personal device that package delivery unit confirmed and current delivery completed 1338 the last Holder device controller read package delivery unit identification tag and stored package delivery identification tag data and position for Delivery management system on holder device 1302. The delivery management system on last holder device matches package delivery unit final destination data and holder device location 1304, if matches 1306 the Delivery management system notify recipient 1308, if not the delivery management system on the last holder device designate courier 1310. And so on until the package delivery unit reaches her destination holder device.

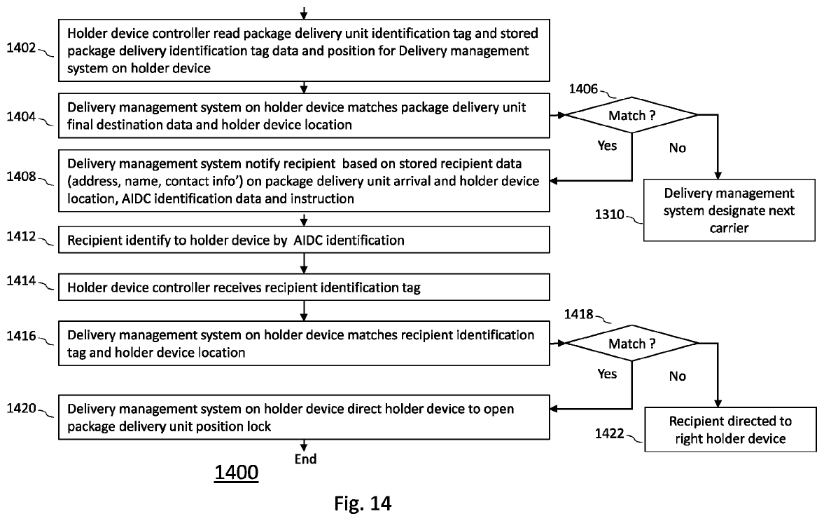

FIG. 14 shows illustrative flowchart of processes performed by a delivery system and method in an exemplary package delivery unit receiving procedure. Holder device controller read package delivery unit identification tag and stored package delivery identification tag data and position for Delivery management system on holder device 1402. The Delivery management system on holder device matches package delivery unit final destination data and holder device location 1404, if the codes don't match 1406, the Delivery management system designate next carrier 1410, if the code matches then the Delivery management system notify recipient based on stored recipient data (address, name, contact info’) on package delivery unit arrival and holder device location, AIDC identification data and instruction 1408. When the recipient arrives to the holder device location, the Recipient identify to holder device by AIDC identification 1412. Holder device controller receives recipient identification tag 1414. Delivery management system on holder device matches recipient identification tag and holder device location 1416, if the codes don't match 1418, the Recipient directed to right holder device 1422, if the code matches then the Delivery management system on holder device direct holder device to open package delivery unit position lock 1420.

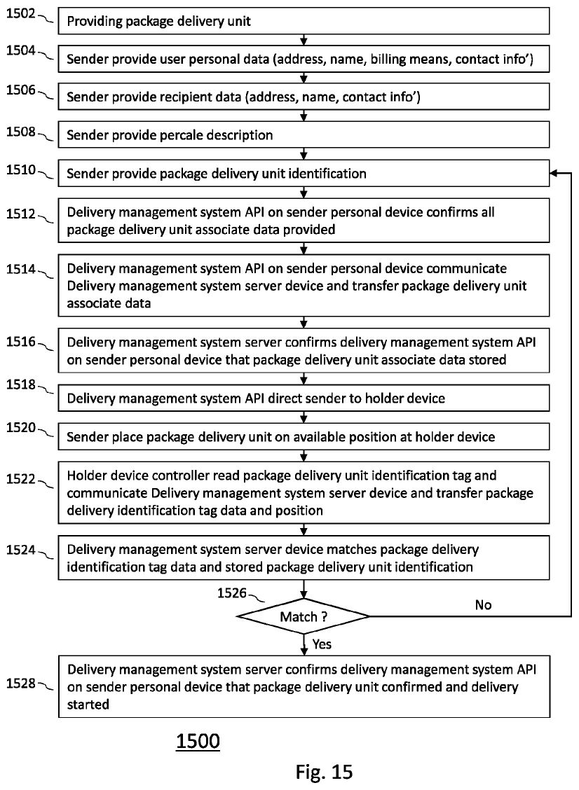

FIG. 15 shows illustrative flowchart of processes performed by a delivery system and method in another exemplary package delivery unit sending procedure. The process starts in providing the package delivery unit 1502 to the sender. The sender provides to the delivery management system API on sender personal device the user (sender) personal data 1504 and recipient data 1506, the user personal data comprises at least the user (sender) address, name, billing means and contact information 1504, the recipient data comprises at least address, name and contact information 1506. The user (sender) can provide percale description 1508. The providing of the data 1504, 1506 and 1508 can be done on the delivery management system API on sender personal device, or by connecting the delivery management system API on sender personal device to the user (sender) database. The user (sender) provide the package delivery unit unique identification 1510, the package delivery unit unique identification can be a numeric/alphabetic code, a QRCODE/BARCODE or an RFID scan tag (representing the same code). The delivery management system API on sender personal device confirms that all the required fields has been filled 1512 and communicate the delivery management system server and transfer package delivery unit associate data 1514, the package delivery unit associate data comprises at least the package delivery unit identification, recipient address, recipient name, recipient contact information and sender contact information. The delivery management system server confirms the user (sender) delivery management system API on the reception of the transferred details 1516, then the delivery management system API on sender personal device direct the sender to the available holder device 1518. After the sender place the package delivery unit in available position in the holder device 1520 the holder device read the package unit identification tag, communicate the delivery management system server and transfer unit identification tag data and position 1522. The delivery management system server matches the package unit identification tag with the stored package delivery unit identification code 1524. If the placed package delivery unit code doesn't match the stored package delivery unit 1526 the sender gets a notification that the codes don't match and a re-identification process is required. If the placed package delivery unit code matches the stored package delivery unit 1526 the sender gets a notification that the codes match and the delivery process has started 1528. In some embodiment the delivery management system server sends a message to the recipience that the delivery is on the way.

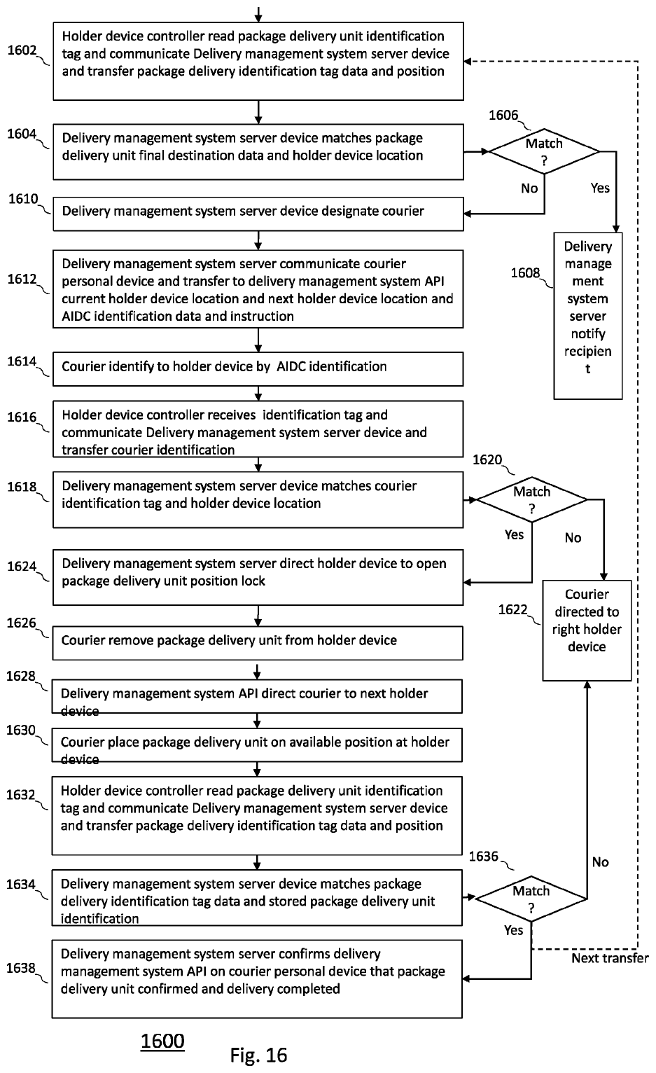

FIG. 16 shows illustrative flowchart of processes performed by a delivery system and method in another exemplary package delivery unit transport procedure. Holder device controller read package delivery unit identification tag and communicates Delivery management system server and transfer package delivery identification tag data and position on holder device 1602. The delivery management system server matches package delivery unit final destination data and holder device location 1604, if matches 1606 the Delivery management system server notify recipient 1608, if not the delivery management system server designate courier 1610. Delivery management system server communicate courier personal device and transfer to delivery management system API current holder device location and next holder device location and AIDC identification data and instruction 1612. Courier identify to holder device by AIDC identification 1614 for arriving at the relevant holder device location. Holder device controller receives identification tag and transfer courier identification to Delivery management system server 1616. Delivery management system server matches courier identification tag and holder device location 1618, if the codes don't match 1620, the Courier directed to right holder device 1622, if the code matches then the delivery management system server direct holder device to open package delivery unit position lock 1624. Courier remove package delivery unit from holder device 1626 and the Delivery management system API direct courier to next holder device 1628. When the courier arrives to the next holder device location the Courier place package delivery unit on available position at holder device 1630. The Holder device controller read package delivery unit identification tag communicates Delivery management system server and transfer package delivery identification tag data and position on holder device 1632. The Delivery management system server matches package delivery identification tag data and stored package delivery unit identification 1634, if the codes don't match 1636, the Courier directed to right holder device 1622, if the code matches then the Delivery management system server confirms delivery management system API on courier personal device that package delivery unit confirmed and current delivery completed 1638. The process 1600 re-start for the next transfer when the Delivery management system server confirms delivery management system API on courier personal device that package delivery unit confirmed and current delivery completed 1638. the last Holder device controller read package delivery unit identification tag and communicates Delivery management system server and transfer package delivery identification tag data and position on the last holder device 1602. The delivery management system server matches package delivery unit final destination data and holder device location 1604, if matches 1606 the Delivery management system server notify recipient 1608, if not the delivery management system server designate courier 1610. And so on until the package delivery unit reaches her destination holder device.

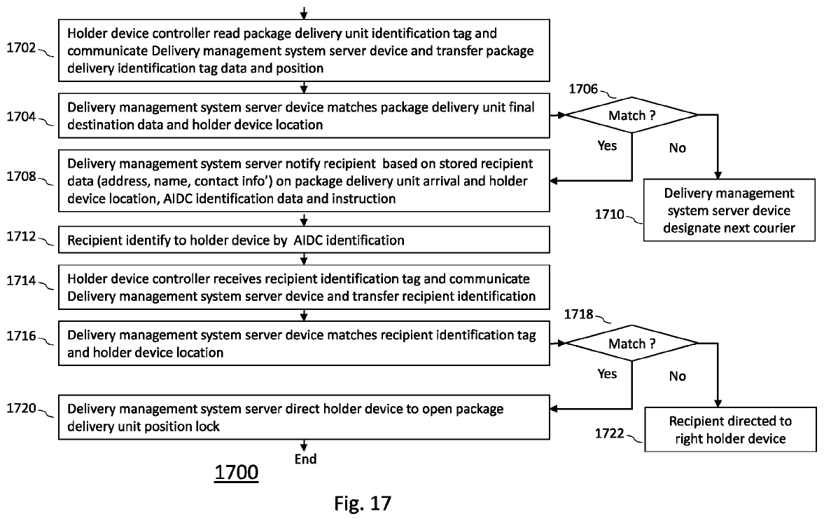

FIG. 17 shows illustrative flowchart of processes performed by a delivery system and method in an exemplary package delivery unit receiving procedure. Holder device controller read package delivery unit identification tag and communicates Delivery management system server and transfer package delivery identification tag data and position on holder device 1702. The Delivery management system server matches package delivery unit final destination data and holder device location 1704, if the codes don't match 1706, the Delivery management system server designate next carrier 1710, if the code matches then the Delivery management system server notify recipient based on stored recipient data (address, name, contact info’) on package delivery unit arrival and holder device location, AIDC identification data and instruction 1708. When the recipient arrives to the holder device location, the Recipient identify to holder device by AIDC identification 1712. Holder device controller receives recipient identification tag and communicates Delivery management system server and transfer recipient identification tag data 1714. Delivery management system server matches recipient identification tag and holder device location 1716, if the codes don't match 1718, the Recipient directed to right holder device 1722, if the code matches then the Delivery management system server direct holder device to open package delivery unit position lock 1720.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments capable of performing the processes of the illustrative embodiments of the present invention can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a courier wave or any other suitable medium from which a computer can read.

While the present inventions have been described in connection with a number of illustrative embodiments, and implementations, the present inventions are not so limited, but rather cover various modifications, and equivalent arrangements, which fall within the purview of the appended claims

1. A computer implemented delivery system comprising:
network of holder devices;
package delivery unit;
plurality of couriers with a courier interface device;
the holder device having an automatic identification and data capture (AIDC) reader, a lock and a controller having a processor, a memory and a communication network interface;
The package delivery unit design to be held and locked by the holder device and having an identification code and AIDC tag;
the courier interface device having a processor, a memory and a communication network interface;
the processor and memory on the holder device controller being configurated to retrieve identification information from the AIDC reader, operate the lock, run a database process and delivery management process, and communicate with other holder device controllers and courier interface device over the communication network interface;
the processor and memory on the courier interface device being configurated to run database process and delivery management process and communicate the holder device controllers over the communication network interface;
the holder device controller is configured to receive and store package delivery unit associated information.
the package delivery unit associated information comprises package delivery unit destination and the package delivery unit identification code;
the courier interface device being configurated to receive courier associated information and being configurated to communicate the holder device controller over the communication network interface and transfer the courier associated information;
the holder device controller is configured to store the courier associated information received from the courier interface device;
the courier associated information comprises courier location, courier destination and courier identification data;
the holder device controller comprises a stored routing table to other holder devices;
the holder device controller is configured to access the stored databases and identify next holder devices location based on the package delivery unit associated information and at least one courier associated information;
the holder device controller is configured to access the stored databases and match at least one of the identify next holder devices location and identified courier interface device and stored routing table, communicate identified courier interface device over the communication network interface and transfer next holder device location;
the holder device controller is configured to open the package delivery unit lock for identified courier interface device.

2. The system of claim 1, further comprising a sender and a sender interface device;
the sender interface device having a processor, a memory and a communication network interface; the processor and memory on the sender interface device being configurated to run database process and delivery management process and communicate the holder device controllers over the communication network interface;
the sender interface device being configurated to receive package delivery unit associated information and being configurated to communicate the holder device controller over the communication network interface and transfer the package delivery unit associated information, when the package delivery unit is placed in the holder device.

3-4. (canceled)

5. The system of claim 1, wherein the routing table are based on Anycast routing, Geographic routing, hybrid routing or any combination thereof.

6. The system of claim 1, wherein the holder device controller communication with other holder devices controller comprise data on current and statistic holder device occupancy and wherein the holder device controller can update routing table in accordance to data.

7. The system of claim 1, wherein the holder device controller further receive data comprising at least one of weather condition, road condition, traffic, news data, statistic road use data, courier's statistic data, statistic packages delivery unit data. and wherein the holder device controller can update routing table in accordance to at least one of receive data.

8. The system of claim 1, wherein the holder device capable to hold and lock more than one package delivery unit and capable to associate package delivery unit identification code and holding position on the holder device.

9. (canceled)

10. The system of claim 1, wherein the AIDC is one of an RFID device, NFC device, Smart card device, Barcode device, QR code device and a Magnetic strip device.

11-12. (canceled)

13. The system of claim 2, wherein the sender interface device comprises AIDC reader device.

14. The system of claim 13, wherein the sender interface device AIDC reader is a camera or RFID device.

15. (canceled)

16. The system of claim 1, wherein the courier interface device comprises AIDC reader and/or a tag, and is a computer or a personal mobile device.

17. (canceled)

18. The system of claim 1, wherein the identified courier removes the package delivery unit from the holder device and place the package delivery unit on next holder device.

19-20. (canceled)

21. The system of claim 1, wherein the couriers can be an occasional courier.

22. The system of claim 1, wherein the package delivery unit transfer from holder device to holder device by couriers and the package delivery unit delivery from initial placed holder device to closets to destination holder device is done in a relay race.

23. The system of claim 1, wherein the holder device controller configured to check if is current holder device location is closest to package delivery unit destination and configured to notify destination contact based on destination contact information from package delivery unit associated information.

24. (canceled)

25. The system of claim 1, wherein one of the holder device controllers is configured to access the stored databases and identify next holder devices location based on the package delivery unit associated information and at least one courier associated information, and configured to access the stored databases and match at least one of the identify next holder devices location and identified courier interface device and stored routing table, communicate identified courier interface device over the communication network interface and transfer next holder device location. And wherein the others holder device controllers are configured to communicate said controller over the communication network interface and transfer locking position of said package delivery unit, the package delivery unit associated information, and receive command to open the package delivery unit lock. And the courier interface devices being configurated to communicate said one holder device controller over the communication network interface.

26. The system of claim 1, farther comprising central management component that can run a database process and delivery management process, and communicate with holder device controllers and courier interface device over the communication network interface; central management component is configured to access the stored databases and identify next holder devices location based on the package delivery unit associated information and at least one courier associated information, and configured to access the stored databases and match at least one of the identify next holder devices location and identified courier interface device and stored routing table, communicate identified courier interface device over the communication network interface and transfer next holder device location. And wherein the holder device controllers are configured to communicate said central management component over the communication network interface and transfer locking position of said package delivery unit, the package delivery unit associated information, and receive command to open the package delivery unit lock. And the courier interface devices being configurated to communicate said central management component over the communication network interface.

27. Delivery system comprising:
network of holder devices at different location each holder device comprising plurality holding position with locks, RFID readers and controller;
package delivery units adapted to be held and lock at holder device position and a RFID tag;
plurality of couriers with a courier interface device;
wherein holder device controller can communicate courier interface device and receive courier current position and destination and match at least one package delivery unit to be transfer to other holder device on the route of the courier in accordance to routing table;
send suggestion to courier interface device to conduct the transfer;
receive confirmation from courier interface device for transfer;
Identify courier interface device and operate locks;
and communicate other holder device in accordance to routing table on transfer.

28. (canceled)

29. The system of claim 27, wherein the package delivery unit route from initial holder device to final holder device comprises at least one additional holder device and the courier transfer is a relay race.

30-55. (canceled)

56. Delivery method comprising:
providing network of holder devices at different location each holder device comprising plurality holding position with locks, RFID readers and controller;
providing package delivery units adapted to be held and lock at holder device position and a RFID tag;
providing plurality of couriers with a courier interface device;
wherein provided holder device controller can communicating courier interface device for receiving courier current position and destination and matching at least one provided package delivery unit to be transfer to other provided holder device on the route of the provided courier in accordance to routing table;
sending suggestion to provided courier interface device to conduct the transfer;
receiving confirmation from provided courier interface device for transfer;
Identifying provided courier interface device and operate locks;
and communicating other provided holder device in accordance to routing table on transfer.

57. (canceled)

58. The method of claim 56, wherein provided package delivery unit route from initial holder device to final holder device comprises at least one additional holder device and the courier transferring is a relay race.

59-108. (canceled)
